(19) United States
(12) Patent Application Publication
(10) Pub. No.: US 2015/0154720 A1
(43) Pub. Date: Jun. 4, 2015

(54) SYSTEM AND METHOD FOR DETECTING AND DEFENDING TRADEMARKS AGAINST SERIAL CYBERSQUATTERS

(71) Applicant: Jonathan Matkowsky, Modi'in (IL)

(72) Inventor: Jonathan Matkowsky, Modi'in (IL)

(21) Appl. No.: 14/271,748

(22) Filed: May 7, 2014

Related U.S. Application Data
(60) Provisional application No. 61/910,447, filed on Dec. 2, 2013.

(51) Int. Cl. G06Q 50/18; G06F 21/10; G06F 17/30

(52) U.S. Cl. CPC G06Q 50/184; G06F 17/30424; G06F 21/10

(57) ABSTRACT

Disclosed is a system and method for enabling serial cybersquatter detection. The disclosed systems and methods provide brand owners the ability to go after serial cybersquatters that are infringing multiple brands in a single proceeding, thereby allowing class complainants to share in the Uniform Dispute Resolution Policy (UDRP) costs and preparation fees. In some embodiments, the disclosed systems and methods provide an online tool that enables researchers to identify serial cybersquatters (e.g., cybersquatters who own dozens, sometimes hundreds of domains containing trademarks). The disclosed systems and methods enable identifying serial violators and connecting brands with each other so they can file a class action suit against an identified cybersquatter.

### CROSS REFERENCE TO RELATED APPLICATIONS

This application claims priority from co-pending U.S. Provisional Patent Application No. 61/910,447, filed on Dec. 2, 2013, entitled System and Method for Detecting Serial Cybersquatters in Real-Time, which is incorporated herein by reference.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to detecting and defending trademarks against serial cybersquatters, and more specifically, to systems and methods to enable trademark owners to reduce their Uniform Dispute Resolution Policy (UDRP) costs by obtaining the information they need to proactively file class complaints, and unmask the true identities behind abusive privacy/proxy registrations (or even if the unmasked identities turn out to be false, discover valuable patterns used in the false contact information to establish common control or origin to combat phishing, advance fee fraud, and rogue networks of online pharmacies that abuse privacy or proxy services).

### RELATED ART

A traditional remedy against cybersquatting has been the UDRP promulgated by the Internet Corporation for Assigned Names & Numbers (ICANN). In November 2011, the Czech Arbitration Court (CAC), an international provider of UDRP services, announced the introduction of a ‘Class Complaint’ procedure into the UDRP, so that a single person representing multiple complainants can file one complaint against a single domain holder in regard to multiple disputed domain names. This procedural option was introduced in response to the requests of right holders for a streamlined UDRP procedure to fight serial cybersquatters. Of course, the system only works if you have identified a serial cybersquatter infringing on multiple complainants' rights, and have a way to collaborate with them. Since 2011 when CAC announced the availability of Class Complaints, there has only been the procedural option of filing a Class Complaint against known serial cybersquatters, but no way of instantaneously identifying them to exercise the option that CAC made available for Class Complaints. Companies like DomainTools provide part of the solution with a Reverse Whois, enabling a brand owner that has identified a domain they want to recover to purchase a report of all domains associated with the registrant's email address or name.

However, a significant percentage of domain names used to conduct illegal or harmful Internet activities are registered via privacy or proxy services to obscure the perpetrator's identity. Privacy registration service offers alternative Whois contact details that belong to the service. A proxy service registers a domain name in its own name and then licenses the use of the domain to a third party (a customer of the proxy service). The Whois system lists the proxy provider as the domain registrant. The use of privacy or proxy services makes it very difficult for a brand owner to balance the costs against the benefits when considering proceedings to defend their rights. There can be significant economies of scale for trademark owners if it can be ascertained that a large number of relevant domains have been registered with essentially identical contact details, which is a motivating factor in using privacy or proxy services. There is extremely high usage of privacy or proxy services for unlicensed pharmacies, typosquatting, and advance fee fraud schemes. Typosquatting is the registration of small variants of the domain name of a legitimate website, frequently used to display a counterfeit mark and competitive pay-per-click advertisements. There is also very high usage for domains used for phishing, as well as for domains subject to UDRP.

When privacy or proxy services are masking the domain's identity, especially given the proliferation of abusive privacy or proxy registrations for typosquatting and domains subject to UDRP, it is expensive to pursue as a matter of course a ReverseWhois on all the privacy and proxy registration service providers. The process of manually analyzing and combing through tens to hundreds of thousands of domain names to find eligible class members is extremely time-consuming.

### SUMMARY

The present disclosure provides systems and methods for remedying shortcomings in the art by enabling serial cybersquatter detection, providing opportunities for exercising the procedural option of proceeding via a class complaint, as well as opportunities for unmasking the true identities behind abusive privacy/proxy registrations (or even if the unmasked identities turn out to be false, discovering valuable patterns used in the false contact information to establish common control or origin to combat phishing, advance fee fraud, and rogue networks of online pharmacies that abuse privacy or proxy services), or having them transferred in bulk by holding the providers responsible. That is, the disclosed systems and methods provides users opportunities to join a network and instantaneously identify top serial-cybersquatters violating their trademark rights, get points for initiating or joining Class UDRP complaints that are automatically redeemed with added potential target respondents (serial cybersquatters) to go after, and a time-based window opportunity (e.g., 30 days) for eligible members to decide whether to join the Class UDRP; and the more members that join, the lower the UDRP costs are generally for each Member. The disclosed system and method provides the platform for the Class UDRP Complaints to be filed for Members. Trademark holders are given the information and collaborative tools that they need to take advantage of the ability to file a Class Complaint against serial cybersquatters that are infringing multiple trademark holders rights in a single proceeding, thereby allowing class complainants to share the UDRP costs and preparation fees. In some embodiments, access to the specific domain privacy or proxy services being abused by serial cybersquatters to violate members' trademark rights is provided to members via the platform, and they receive points for initiating or joining class UDRP complaints to “lift the curtain” and reveal the true owner(s) of the domains, or to hold the providers responsible so that economies of scale can be achieved. This is done through the disclosed systems and methods enabling the commencing of a Class complaint against the domain privacy or proxy provider in the first instance; if the service does not unmask the true owner(s) or the underlying contact details that even if spoofed, can provide trademark holders the data to tie domains to a single phishing network or rogue Internet pharmacy network, then the proceeding continues to decision against the privacy service itself. When the proxy service provider cooperates, and there are a couple or more owners of the domains revealed after the curtain is lifted, the typical approach unless there is some evidence that they are under common control, is to allow the case to go to decision against one of the respondents and then the complainants have a chance to bring new proceedings against the other respondents. Because it requires incurring fees and costs to actually commence a proceeding, traditionally the UDRP would only be filed against a privacy or proxy service provider if a trademark owner detects a domain that they need or want to reclaim in and of itself. As previously mentioned, one reason the malicious activity is undertaken behind the privacy or proxy is to prevent the trademark owners from achieving economies of scale.

In accordance with the present disclosure, because the system discloses opportunities where privacy or proxy services are being abused by serial cybersquatters, the trademark holders can utilize the class UDRP process to lift the curtain and identify one or more groups of class complaints against specific serial cybersquatters; alternatively, they can use the class UDRP process to reclaim their domains from the domain proxy or privacy service provider unwilling to unmask the domains. While nobody can compel the privacy to be lifted, from the standpoint of the class complainants′, it is a victory as they can generally proceed against the service provider. In other words, conventionally, it would be perceived as too expensive to bring a single UDRP against all the privacy or proxy services just to find out the identity of the potential targets that would have to be arbitrated against individually, thereby incurring independent costs and fees for each UDRP against potentially a myriad of respondents. But in some embodiments, the disclosure makes it a viable option because the proceedings can be split into multiple class complaints against each of the underlying serial cybersquatters, and economies of scale can be achieved by proceeding as a class. The disclosure automatically alerts members to specific opportunities to proceed as a class against such proxy or privacy registrations by pinpointing common members' trademarks being abused by the same privacy or proxy service.

In some embodiments, the disclosed systems and methods allow legal representatives of trademarked brands to quickly identify serial cybersquatters who are infringing on their trademarks and facilitate a class UDRP against the cybersquatter in conjunction with other trademark holders. Thus, collaboration with other eligible members of the class can reduce UDRP costs and preparation fees and increase effectiveness of such proceedings because, i.a., the very status of serial cybersquatting is a factor of bad faith, one of the essential elements necessary to prevail in a UDRP.

In accordance with one or more embodiments, a method is provided for identifying serial cybersquatters that are infringing multiple brands in a single proceeding, thereby allowing class complainants to share in a UDRP Class Complaint.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for identifying serial cybersquatters that are infringing multiple brands in a single proceeding, thereby allowing class complainants to share in a UDRP Class Complaint.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic block diagram illustrating components of a system in accordance with embodiments of the present disclosure;

FIG. 4 is a flowchart illustrating steps performed in accordance with some embodiments of the present disclosure;

FIGS. 5A-5J depict wireframes from an exemplary network UI in connection with FIGS. 3-4, in accordance with some embodiments of the present disclosure; and

FIG. 6 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many different forms. Trademark owners have a duty to enforce their trademarks to protect the public. Indeed, their legal representatives must implement cost-effective solutions against continuous onslaught of infringing activities. Currently, when someone registers a string of characters that are identical or confusingly similar to a protected trademark, the trademark holder (also referred to as the brand owner or rights holder) can bring a dispute resolution proceeding (DRP) under the Uniform Dispute Resolution Policy (UDRP).

By way of background, the UDRP was promulgated by the Internet Corporation for Assigned Names and Numbers (ICANN) as a cost-effective solution for trademark owners to reclaim domain names without having to file a court case. However, the combination of arbitration costs with the legal fees in preparing a UDRP can lead a proceeding to cost upwards of $3000. Additionally, there are typically more infringing domain names in existence per brand than any one brand owner can afford to regularly enforce against. Indeed, the ruling panel in such cases can only order the domain name to be transferred, and cannot award monetary damages or attorney fees. In such cases, the only way to recover monetary damages is to bring a court action against the domain name or the registrant. Doing so for every case of cybersquatting is generally not practical, and the UDRP was set up to enable rights' holders to “recover” domain names without having to bring a court action. However, given that cybersquatting is so prolific, it has become difficult for rights holders to bring a DRP against every cybersquatter infringing on their brand, and most rights holders will prioritize going after the most valuable domain names and those registrants who have registered multiple domain names so that they can be recovered in the same proceeding.

The disclosed systems and methods discussed herein provide solutions enabling brand holders to initiate or bring more cost effective UDRP proceedings via, for example, the CAC by exercising the option of initiating class complaints, and to utilize the same as a means of combatting privacy or proxy registrations abused by any domain registrant with a domain subject to UDRP, inclusive of not only typosquatting domains, but domains being used by, for example, rogue online pharmacies, advance fee fraudsters, as well as phishing attacks, and the like. Thus, as discussed in more detail below, upon identifying combative registrations, the disclosed system enables the initiation of a domain name dispute (e.g., UDRP complaint) where a rights holder is afforded the opportunity, either personally, collectively with other rights holders and/or through third party platforms, to invoke or learn about invoking his/her legal rights against the identified registrant. The disclosed systems and methods provide brand holders new tactics to pursue serial cybersquatters through Class Complaints or other actions as a matter of strategy, inclusive of the privacy or proxy providers offering a shield to such registrants. As used herein, the terms initiate or invoke are used interchangeably to mean initiating, filing, starting, joining or otherwise causing, directly or through one or more third parties or agents, along or with others, a domain name dispute to be brought against a cybersquatter.

The disclosed systems and methods discussed herein provide solutions enabling protection not only against domains subject to the UDRP per se, or domains that are subject to only trademark violations. For example, if a criminal network of rogue online pharmacies owns even a couple of domain names re-directing to their rogue online pharmacies, the system enables the owners of such trademarks being exploited to learn more about the owners of the criminal network. By way of illustration only, if the names of prescription drugs are entered into the system, such as CIALIS and VIAGRA owned by Elly Lilly and Pfizer, respectively, the system will automatically detect that someone with the email address of athardy@comcast.net has registered www-cialis.com and www-viagra.com (as well as www-viagra.net) to redirect such domains to rogue online pharmacies. This enables such pharmaceutical companies to file a UDRP against athardy@comcast.net and reclaim such domains cost-effectively through a class complaint. It should be noted, however, with respect to this illustration and the entire benefit of the disclosure as it relates to the class complaint procedure made available by CAC, that it is illustrative only. As either Pfizer or Elly Lilly in this example, could use the disclosure in other beneficial ways, such as to take action individually in a court instead of via ICANN arbitration to combat falsified medicines online or on the ground. The same is true for phishing and advance fee fraud to the extent domains are being used as part of the fraud across multiple domains, which is at least likely, if not extremely likely when it comes to these types of abuses via the domain name system.

The present disclosure describes techniques for flagging a cybersquatter with the largest domain portfolio (e.g., a cybersquatter who is infringing on the highest number of trademark owners' rights). This enables a brand holder to split the cost of a class complaint with the most number of brand holders in order to exercise the option of filing a Class Complaint before CAC. Even if brand holders did not want to proceed as a class, they can use the intelligence to proceed independently against targets. As previously mentioned, the fact that an infringer has a pattern or practice of registering confusingly similar or identical domains to trademarks is a factor that is considered in the calculus of whether such person has bad faith intent to profit from a trademark holder's rights. Therefore, the fact that a trademark holder is able to identify a serial cybersquatter using the system gives them substantive evidence that such person has acted in bad faith and is in violation of their rights. With this solution, the cost of bringing a UDRP is significantly lowered even if they proceed independently, but especially if they proceed as a class, thereby enabling a brand owner to bring more DRPs within a given budget. Indeed, the brand holder(s) can recover the most number of domains from the bad-actors who most clearly have bad-faith. By way of further example, if two trademark holders desired to collaborate specifically with one another because they are affiliated, or for other legitimate reasons, the disclosed systems and methods discussed herein provide them a way to find opportunities because one can cross-check the brands to find such opportunities.

The disclosed systems and methods discussed herein provide solutions enabling brand holders to not only share the cost of a UDRP, but to potentially share the costs of preparing a DRP complaint or lawsuit that is not subject to the class complaint procedural rules governing gTLDs because the same representatives can proceed in parallel on behalf of multiple brand holders, thereby avoiding duplicative efforts and consequently, resulting in savings for the brand holders. It also enables a specific brand holder to enhance its independent enforcement initiatives by gathering evidence of bad-faith automatically via the network.

As discussed in more detail below, the disclosed systems and methods discussed herein provide solutions enabling brand holders to not only proceed against the specific domains that may have been flagged by the algorithms used to identify identical or confusingly similar domains, but to also share the cost of purchasing a Reverse Whois report from a company such as DomainTools via use of its API integrated into the system to get a complete record of the current portfolio of the cybersquatter, as well as historical data. This can be used to find additional evidence of bad faith, additional brands that the cybersquatter has in their portfolio, or additional domains that are not even confusingly similar, but are nonetheless being used as part of fraudulent schemes, such as advance fee fraud, counterfeiting, rogue networks of online pharmacies, or phishing.

As discussed in more detail below, one factor in deciding bad-faith (a component of liability in a proceeding) is whether the registrant has a pattern or practice of cybersquatting, i.e., is a serial cybersquatter. The solution discussed herein gives the brand holders the best chance of success in a DRP because the targets are by definition, serial cybersquatters who are infringing on the most number of trademarks. From a deterrent standpoint, through the implementation of the systems and methods discussed herein, companies have a chance to change the economics of the domain industry in favor of trademark owners and against serial cybersquatting. Currently, serial cybersquatters calculate that even if they have to give up a small portion of their portfolio in a UDRP, they still have a large portion of their portfolio intact since it is not cost-effective for brand owners to file as many UDRP actions as it would take to discourage them from registering them in the first place. Thus, the disclosed systems and methods remedy shortcomings in the field by enabling brand owners to collaborate against the serial cybersquatter, thereby effectuating serial cybersquatters to lose a majority of their domain portfolio from a single UDRP proceeding.

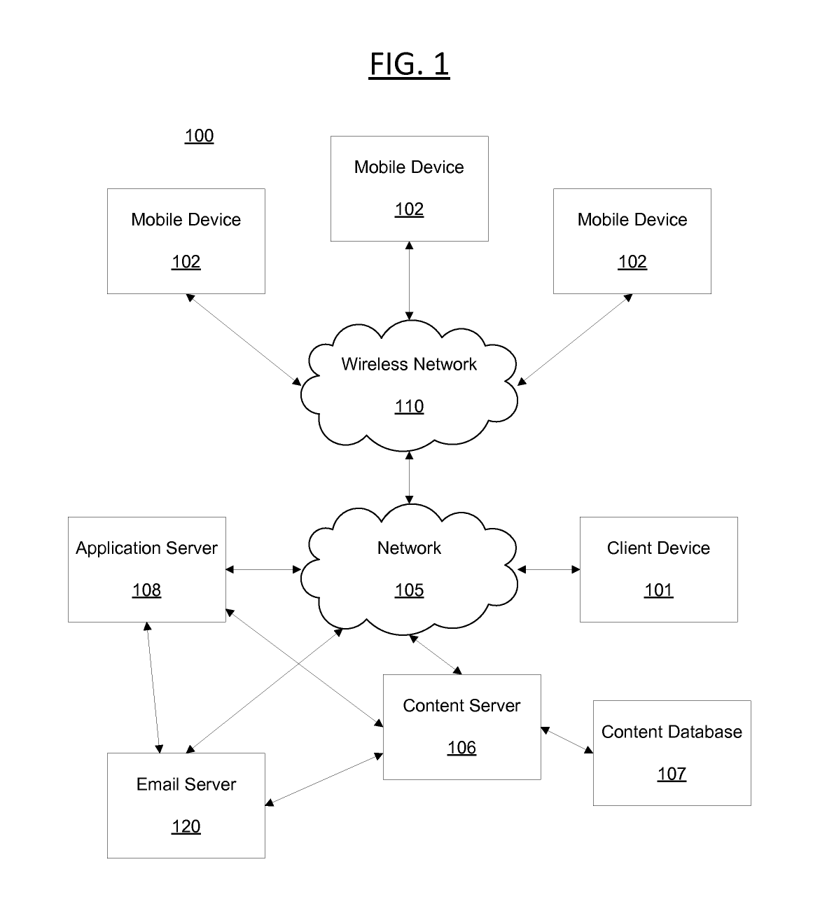

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108, and an email server 120.

One embodiment of mobile devices 102-103 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, share photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-104 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including 2nd (2G), 3rd (3G), and/or 4th (4G) generation radio access for cellular systems, WLAN, Wireless Router (WR) mesh, and the like. Access technologies such as 2G, 3G, 4G and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device s 102-104 and another computing device, network, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content servers 106, application server 108, client device 101, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within a social networking site. A social network refers generally to a network of individuals, such as acquaintances, friends, associates, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site, such as a social networking site or an email/messaging platform, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, email services, photo services, web services, third-party services, audio services, video services, email services, instant messaging (IM) services, SMS services, MMS services, FTP services, voice over IP (VOIP) services, or the like. Such services, for example the email services and email platform, can be provided via the email server 120. Examples of content may include images, text, audio, video, or the like, which may be processed in the form of physical signals, such as electrical signals, for example, or may be stored in memory, as physical states, for example.

Servers 106, 108 and 120 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In an embodiment, users are able to access services provided by servers 106, 108 and/or 120. This may include in a non-limiting example, email servers, social networking services servers, SMS servers, IM servers, MMS servers, exchange servers, via the network 105 using their various devices 101-104. Moreover, although FIG. 1 illustrates servers 106, 108 and 120 as single computing devices, respectively, the disclosure is not so limited. For example, one or more functions of servers 106, 108 and 120 may be distributed across one or more distinct computing devices. Moreover, in one embodiment, servers 106, 108 and 120 may be integrated into a single computing device, without departing from the scope of the present disclosure.

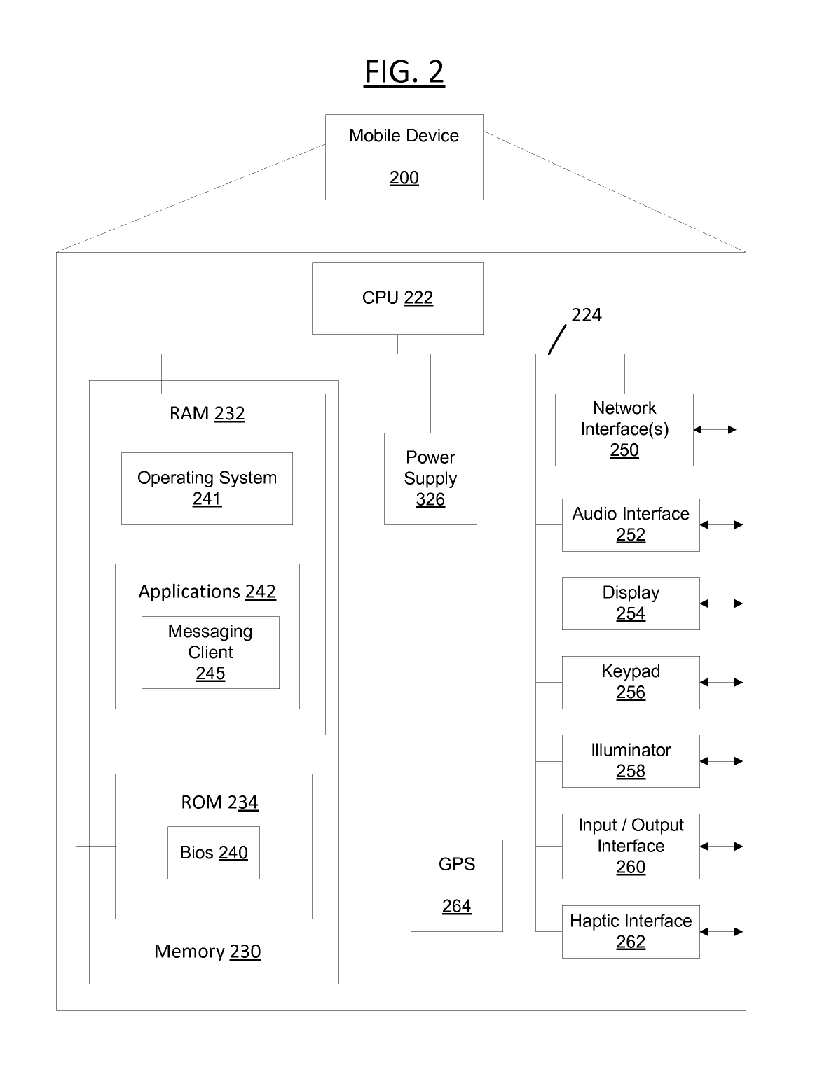

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using email, SMS, MMS, IM, VOIP, and/or any of a variety of other messaging communication protocols. Although a single messaging client 245 is illustrated it should be clear that multiple messaging clients may be employed. For example, one messaging client may be configured to manage email messages, where another messaging client manages SMS messages, and yet another messaging client is configured to manage serving advertisements, IMs, or the like.

Having described the components of the general architecture employed within the disclosed systems and methods, the components' general operation with respect to the disclosed systems and methods will now be described.

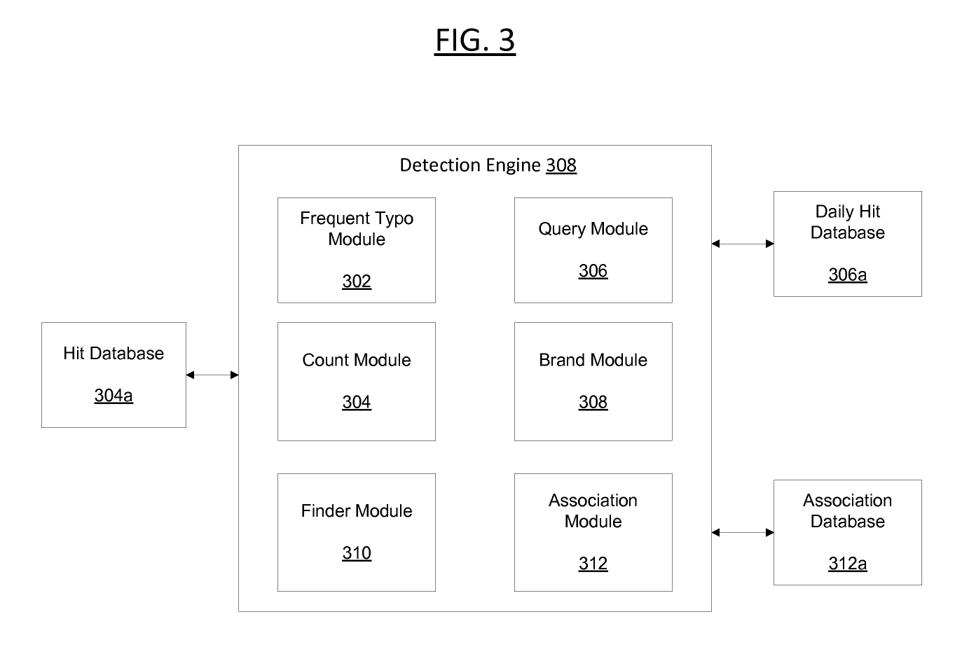

FIG. 3 is a block diagram illustrating the components for performing the systems and methods discussed herein. By way of some additional background, in connection with the above discussion, in connection methods and techniques used by cybersquatters to obtain domain names, it is known that there are certain typographical errors that are more common than others. Since cybersquatters often exploit typographical errors to yield higher Internet traffic to cybersquatted sites, the present disclosure, according to some embodiments, targets cybersquatters that are actively registering or who have in the past registered domains employing one of the most frequent typographical errors.

For example, let a trademark equal BRAND for purposes of non-limiting illustration. One of the most common typographical errors that is of the highest value traffic-wise is leaving out the period in between WWW and the BRAND, i.e., wwwBRAND.com instead of www.BRAND.com. Another example is leaving out the period before the.com in the.com generic top-level domain (gTLD) space, e.g., BRANDcom instead of BRAND.com. When someone types Brandcom thinking they typed brand.com, often there will be some kind of auto-population (via the browser or other helper app) of characters leading to BRANDcom.com. This is another common typographical error and will also be used for purposes of disclosing the functions of the systems and methods discussed herein. It should be noted that these examples are for illustration purposes only, and anyone skilled in the art of brand protection will understand which typographical errors are most common and which errors facilitate the manipulation of a brand for the deception of the general public, either historically or over time or in the future. As noted previously, these typographical errors, and others, are also used for fraudulent schemes involving re-directing domains to rogue online pharmacy networks, or advance fee fraud or phishing schemes, not only to display counterfeit marks with competitive pay-per-click ads.

As such, the present disclosure involves systems and methods enabling serial cybersquatter detection to remedy such situations. That is, the present disclosure provides brand owners the ability pursue serial cybersquatters that are infringing multiple brands in a single proceeding, thereby allowing class complainants to share in the Uniform Dispute Resolution Policy (UDRP) costs and preparation fees. In some embodiments, the disclosed systems and methods provide an online tool that enables researchers to identify serial cybersquatters (e.g., cybersquatters who own dozens, sometimes hundreds of domains containing trademarks). In other embodiments, the disclosed systems and methods provide an online tool that enables brand owners and researchers to identify perpetrators of rogue Internet pharmacies, as well as advance fee fraud and phishing perpetrators. In other embodiments, the disclosed systems and methods provide an online tool that enables brand owners and researchers to identify the most abused privacy or proxy registration service providers with respect to their brands. Thus, the present disclosure enables brand owners the ability to identify serial violators and connect with other brand owners so they can take collective action or coordinate to reduce their cost through parallel litigation, whether by filing a class complaint via CAC, or other means of arbitration or litigation against an identified cybersquatter or their privacy or proxy registration service provider. In other embodiments, those involved with combatting rogue online Internet pharmacies can identify registrars most being abused through re-directing typo variations of prescription drugs to rogue online Internet pharmacies, or for phishing or advance fee fraud as all the Whois and ISP data sets can be retrieved once the domain names are identified that have been registered by serial cybersquatters. Serial cybersquatters are by definition, more likely to be involved with phishing, advance fee fraud and rogue online Internet pharmacies as the perpetrators often do not target a single brand holder but multiple ones.

FIG. 3 includes a detection engine 300 for performing the systems and methods discussed herein. The detection engine 300 includes a frequent typo module 302, a count module 304, a query module 306, a brand module 308, a finder module 310 and an association module 312. As discussed in more detail below, the detection engine 300 has at least one associated database for compiling and storing the information analyzed and produced from each module. That is, for example, the count module 304 has an associated database referred to as a hit database 304a. Each associated database respective to each module will be discussed in more detail below. Embodiments exist where each database is connected to the detection engine 300 as a whole, and in some embodiments, each database corresponds directly to an individual module. It should be understood by those of skill in the art that each database may be locally affiliated with the engine, or connected via a network connection to the engine for storing and maintaining the relevant information. Indeed, each database can be any type of database or memory that can store information related to data compiled and analyzed by each module in engine 300, including but not limited to, a brand owner, a cybersquatter, a domain, a UDRP proceeding, and the like.

Furthermore, it should be understood that the engine(s) and modules discussed herein are non-exhaustive, as additional or fewer engines and/or modules may be applicable to the embodiments of the systems and methods discussed. The operations, configurations and functionalities of each module, and their role within embodiments of the present disclosure will be discussed below, whereby the components of engine 300 are implemented to perform the steps and processes disclosed systems and methods.

The frequent typo module 302 identifies and records the most common typographical errors (e.g., every digit, every letter) against every character that can technically comprise a domain name. By way of a non-limiting example, and solely for purposes of illustration, given that www typos are of the most common typographical errors, the frequent typo module 302 can compile a list that includes: wwwa, wwwb, wwwc, wwwd . . . wwwz, and www1, www2 . . . www9. The list can also include acom, bcom, ccom, dcom, and every other letter or digit that can be typed before the period in the.com space. The list can additionally include, for example, 1net . . . 9net, and anet . . . znet to capture domains in the .net space where the period was left out.

All of these strings of characters are put into the frequent typo module 302. The frequent typo module 302 can implement any type of known or to be known typo generator/identifier technique or algorithm to identify and record such errors. The frequent typo module 302 then runs such list(s) against newly registered domain names as a monitor. Such comparison algorithms and techniques can be performed by any known or to be known comparison or mining algorithm/technique. For example, DomainTools has a program known as a Brand Monitor Alert, in which a user can set up Boolean strings of characters to be monitored against newly registered domains, and the Brand Monitor Alert will alert the user when a domain containing that particular string of character is registered. For purposes of discussion throughout the present disclosure, it is assumed that “wwwg” has been identified by the frequent typo module 302, as discussed above, and that it is run against newly registered domains—in the case, for example, that someone registered wwwgoogle.com. Thus, the detection engine 300 would count that as a “hit”. Such identification of a “hit” is performed by the count module 304. As mentioned above, the count module 304 has an associated hit database 304a, which compiles all “hits” identified from the comparison performed by the frequent typo module 302, in addition to the information generating the “hit”.

The query module 306 involves querying each domain identified in the hit database 304a using the Whois protocol to identify the registrant information. That is, the query module 306 reviews, for example, the Whois record containing the registrant information—which can include, but is not limited to, the registrant's email address and administrative contact email address (referred to as “admin-c” email address). The registrant's email address or admin-c email address identifies the registrant of the domain name that is being queried. The query module 306 then performs a Reverse WhoisLookup using DomainTools API to determine how many domains are associated with the registrant email address or identified admin-c email address. This number indicates how large the domain portfolio is of the registrant of the typo. The more domains in the portfolio, the more of interest that registrant may be, because it indicates that it is possible that he is infringing on a larger number of domains as he or she has a larger domain portfolio. The domain name, registrant name, the admin-c email address, and the number of domains associated with the registrant or that admin-c email address is then transmitted to another database, referred to as a daily hit database 306a, where such information is recorded. If that registrant or admin-c email address is already in the Daily Hit Database, then it is deduped so that a new entry is not created, but rather the most up to date number of domains is recorded. Additionally, instead of just recording one domain that triggered the Whois Lookup, the additional domain could also be recorded. Thus, this daily hit database 306a is updated daily (or according to a more applicable period range, such as for example hourly, weekly, or some other interval) without duplicate entries. As discussed above, it should be understood that the daily hit database 306a and the hit database 304a can be one database, where the separate information is stored in identifiable data structures for easy retrieval and processing.

According to some embodiments, processes of identifying registrant information (e.g., registrant email address) can account for hidden registrant information. That is, some privacy or proxy service providers utilize unique email addresses for registrants. For such services, the domain name in the email address may remain the same as that of the privacy service. Therefore, the query module 306 can strip down (or parse or mine) the unique email address to the domain name associated with the privacy service in order to group all the domains together that are registered by the same privacy or proxy service. This can occur despite each domain receiving a unique email address (or ID number). The benefits of performing such stripping/parsing and grouping, as discussed herein, can be realized from the standpoint of taking remedial action collectively or in parallel, such as a class complaint UDRP. That is, the domains can be grouped together and counted as registered by the privacy or proxy service. As previously indicated, from this point, the onus is then on the service to reveal what lies behind the “curtain.” For example, a proceeding can be split against multiple respondents, so instead of there being one class complaint, there may be two. In some cases, this enables the determination of the identity of the “hidden” registrant, thereby unveiling registrant's identity from within the privacy or proxy service. As understood by those of skill in the art, this can reduce the costs of enforcement, including via a Class Complaint before CAC when a privacy or proxy service provider's services are being abused across brands.

The detection engine 300 also includes a brand module 308, which compiles a list of all the famous brands globally that may be interested in brand protection. For example, one string of characters in the Brand Engine may be Google. This list may be compiled based on the web-presence of a brand, and/or the activity of a brand's trademark registration activity being above a threshold. (Note, such activity can be monitored via third parties, and/or via the USPTO website). It also may be compiled as members of the network sign up for use of serial cybersquatter detection tool.

The finder module 310 involves performing a search for typosquats for each brand identified by the brand module 308. As understood by those of skill in the art and previously indicated, a typosquat is a form of cybersquatting that relies on mistakes such as typographical errors made by Internet users when inputting a website address into a web browser. That is, should a user accidentally enter an incorrect website address, they may be led to any URL (including an alternative website owned by or affiliated with a cybersquatter; for example, rogue online Internet pharmacies rely on affiliate marketing techniques, which includes re-directing typosquats to the rogue online pharmacies within the criminal network, especially because the sites themselves are often removed by search engines, and the criminal networks need to use other means of obtaining traffic to their sites). Once in the typosquatter's site, the user may also be tricked into thinking that they are in fact in the real site, or at a site approved by, sponsored by, or otherwise affiliated with the legitimate site they were seeking; this may be achieved through the use of copied or similar logos, website layouts or content.

The search performed by the finder module 310 can, in some embodiments, be performed via a third party site/vendor, such as, but not limited to, DomainTools®. It should not be construed that the present disclosure is limited to relying upon, or implementing such third party tools, as the present disclosure comprises embodiments that involve the detection engine 300 (and/or modules or sub-modules of such) performing such processes.

For example, DomainTools® has a Domain Typo Finder, where the system (or a user) can filter the results to registered domain names and query a string of characters to find registered domains that are typos of that string (e.g., letter swaps, Qwerty slips, lookalikes, soundalikes and the like). Thus, the finder module 310 enables each brand identified by the brand module 308 to be compared against the filtered results from the search. Such comparison involves filtered registered domains, where the results of the comparison are communicated to the association module 312, as discussed below. In some embodiments, the results are also stored in an association database 312a, which stores the registered typosquats of each brand in the brand module 308. (Note, as discussed above, it should be understood that the daily hit database 306a, the hit database 304a and the association database 312a can be one database, where the separate information is stored in identifiable data structures for easy retrieval and processing.

By way of a non-limiting example, registered domain “goole.com” is recorded in association with the association module 312 (and association database 312a). Then a Whois Lookup is performed on that domain registrant name John Smith and the registrant email address is john@stonecrossrigg.co.uk are identified and recorded in association with goole.com. A Reverse Whois Lookup (e.g., using DomainTools API) is then performed using the email address john@stonecrossrigg.co.uk, and a hit count is determined for the registrant. For example, if the registrant email address is associated with 21 other domains, the number 21 is recorded as a line entry as a “score” showing how many domains are in that portfolio. Every domain entered in the association module 312 is grouped by brand. If the next day John@stonecrossrigg.co.uk shows up against a different brand, it is recorded as an entry as well, in addition to another calculation regarding how many brands are identified. Thus, the tracking and monitoring of domains and the number of domains are performed in near real-time.

By way of another example, if yesterday John Smith had 21 domains, but then registers a 22^{nd} domain, the number of domains correlating with John Smith would be updated to 22. Thus, in connection with the above example, John Smith would have a hit score indicating two (2) brands and 22 domains. The entries via the association module 312/association database 312a are only updated to reflect changes.

The association module 312 additionally involves cross-searching the email address associated with the admin-c email or registrant email address in the daily hit database 306a with the hit database 304a. If there is a match, the association module 312 tags each entry to indicate that there is a common typo of brands occurring in the brand module 308. Such results are iteratively and continuously being sorted in near-real time (or substantially simultaneously within system processing and latency constraints) in accordance with the number of domains in the portfolio of the user associated with the admin-c email or registrant email address, the number of brands in the brand module 308 that have a hit against the registrant or admin-c email address. In some embodiments, these sorted results can be weighted so that the higher number of brands that the email address is associated with receives a higher score than if it were associated with a fewer number of brands.

Furthermore, in some embodiments, if an admin-c email or registrant e-mail address is associated with more domains but the same number of brands, it can receive a higher score because of the larger portfolio even though there are only hits against the same number of brands. Thus, for example, if John@stonecrossrigg.co.uk shows up against 5 different brands in the brand module 308, and only has 21 domains associated with that email address, it would get a lower score than jonathan@example.com being associated with 5 different brands if jonathan@example.com was associated with 35 different domains. This way the registrant email address associated with the largest number of domains and with the biggest portfolio of domains will be flagged as most important.

According to some embodiments, the detection engine 300 can filter the results so that only what is related to a specific brand in the brand module 308 is available. This can facilitate alerting a specific brand owner to a serial cybersquatter that has the biggest portfolio, and/or the most number of brands in their portfolio being infringed. According to some embodiments, a master list (referred to as a “white list”) can be maintained by the detection engine 300. The white list can include admin-c email addresses or server names associated with the particular brand owner, so that when a brand owner (e.g., famous brand owner) that registers a lot of domains registers a typo for defensive reasons, that domain would not give rise to a “hit” count or score, but would be filtered out. According to some embodiments, the detection engine 300 may also include a privacy or proxy service module. Such module may entail the processing of a separate list being tracked with respect to algorithms tied to each of the privacy or proxy service providers and how they operate (e.g., which email addresses to parse down to the domain level to cause them to be grouped by such provider rather than by email address).

The detection engine 300 discussed above allows users (e.g., brand owners) the ability to identify serial cybersquatters. For example, identified cybersquatters can include the “worst actors” insofar as they register common typos and have the largest number of infringing activities respective to registered brands and brand names. Thus, the detection engine 300, being implemented by the disclosed systems and methods discussed herein, enables users (e.g., brand owners and/or representatives of such owners, such as, but not limited to, lawyers or legal service providers) to identify and locate serial cybersquatters. In one embodiment, a user can narrow down the brand engine to include only specific prospective clients or existing clients, thus finding target bad actors relevant to their client base of interest.

Implementing the detection engine 300, as discussed below in more detail, brand holders can also decide they want to generally collaborate with one another through a cybersquatter detection network. Such cybersquatter detection tools discussed herein allows users to know who to target for class action DRPs, as well as finding targets of the worst serial cybersquatters, or the worst serial cybersquatters filtered to include at least certain brands or a single brand. Because ordering a Reverse Whois Look up can get very expensive for a brand owner, given the size of a cybersquatter's portfolios and that the larger the portfolio the greater the cost to order the domains in that portfolio, disclosed systems and methods enable narrow targets to be identified and more closely examined by ordering a complete list of all domains in that portfolio. The disclosed systems and methods can then look for additional typos of the brands that triggered the hit score to begin with, thus finding additional domains in the portfolio that are typos of specific brands of interest. Therefore, as discussed in more detail below, through implementation of the detection engine 300, the disclosed systems and methods provide brand owners the ability to go after serial cybersquatters that are infringing multiple brands in a single proceeding or in parallel action, thereby allowing class complainants to share in the costs and preparation fees (e.g., by way of Class UDRP before CAC). That is, rather than a single brand trying to reclaim its own domains alone, a brand owner can identify serial violators infringing on specific other brand holders' rights, and connect with the relevant other brands in order to collaborate with them and reduce costs, such as, but not limited to, by filing a Class Complaint before CAC against the identified cybersquatter or privacy or proxy registration service provider.

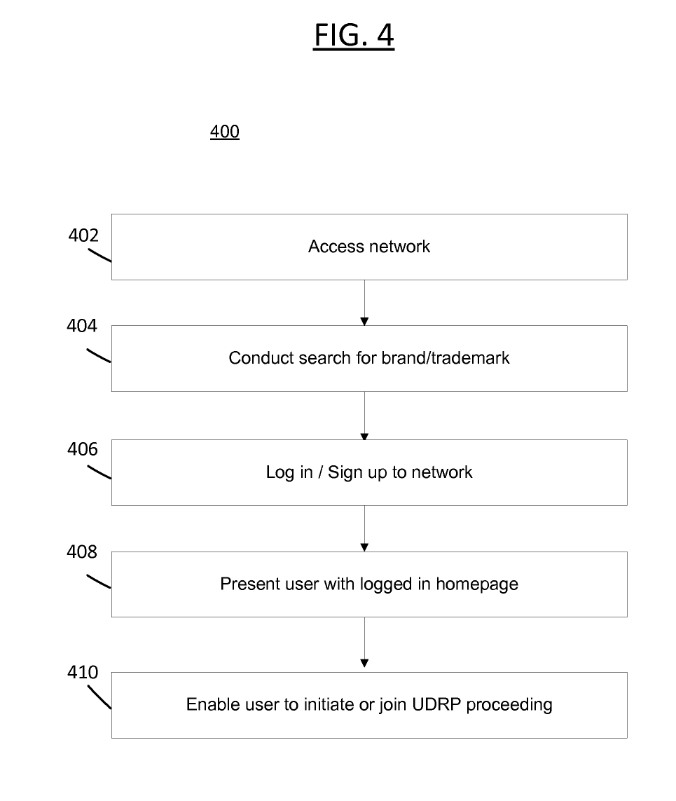

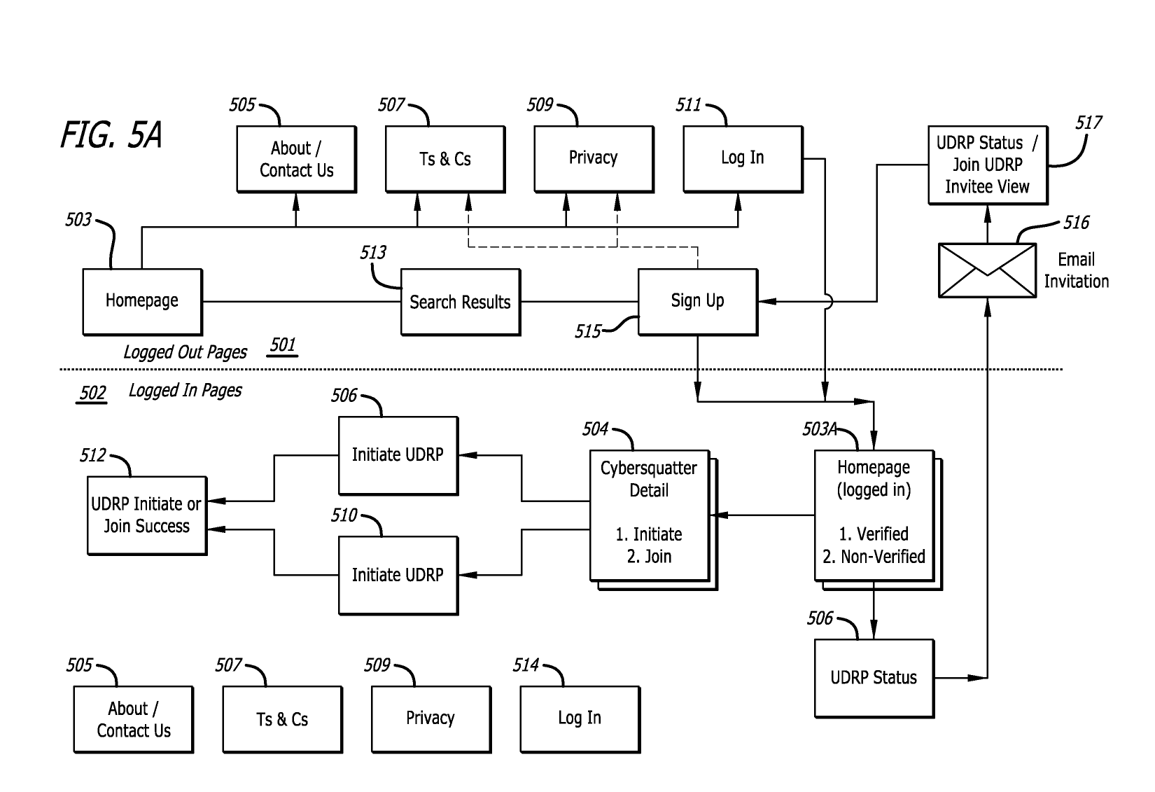

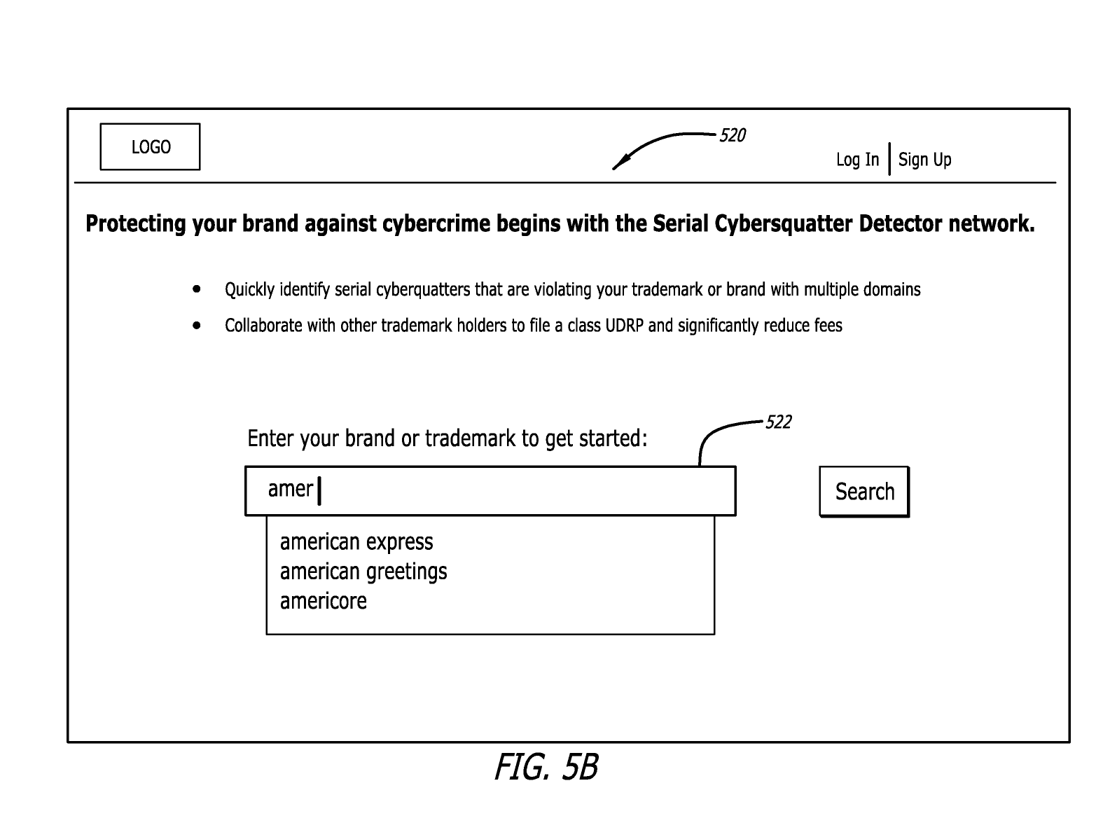

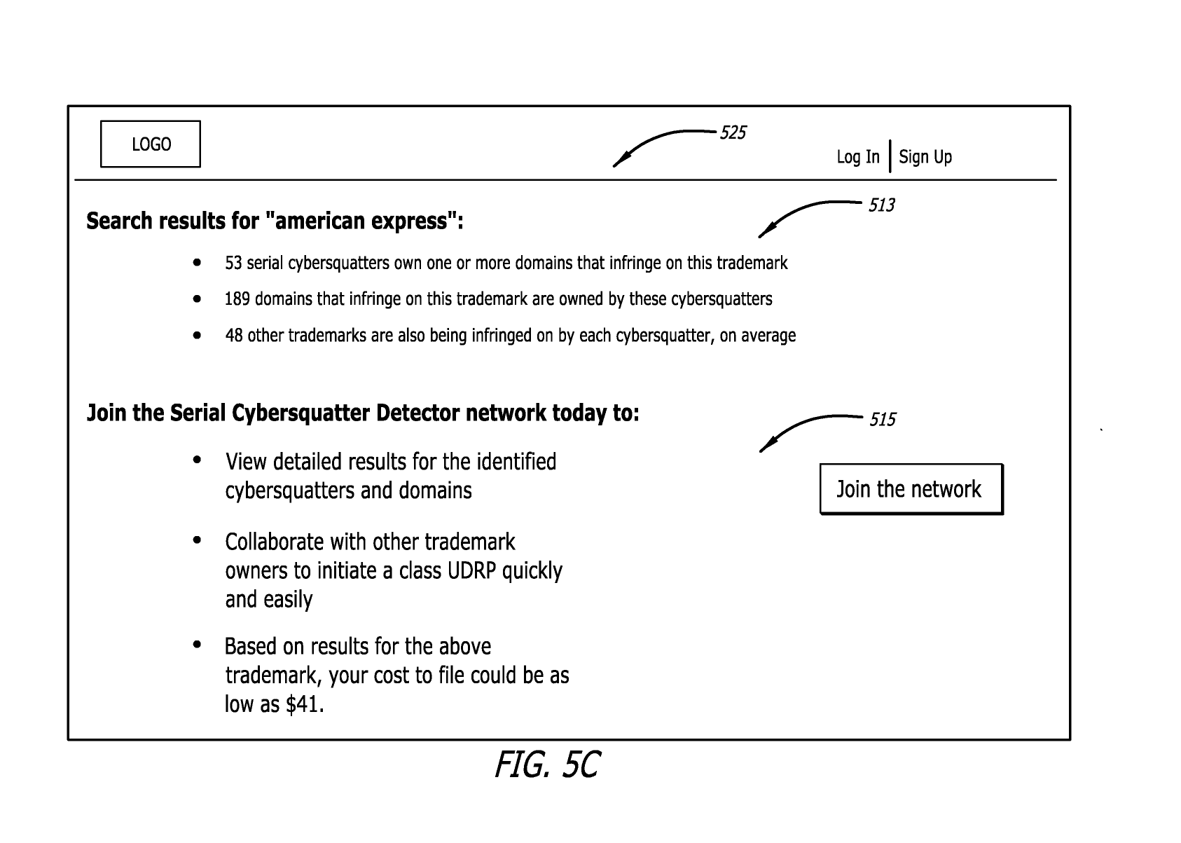

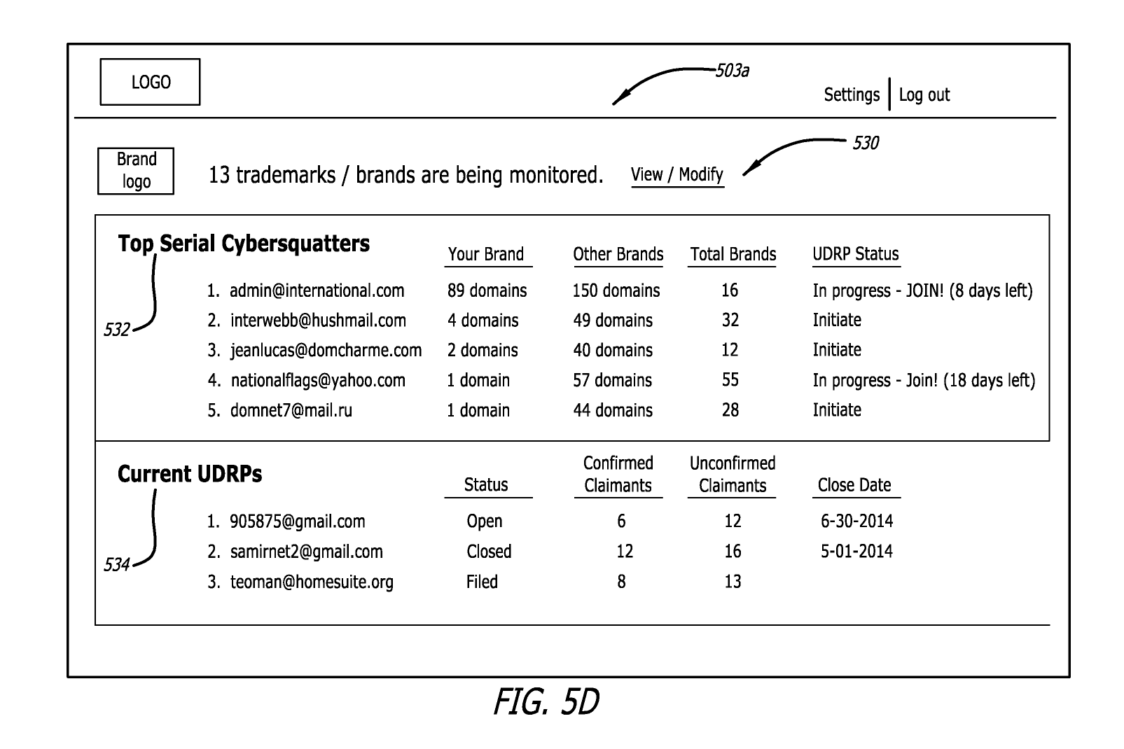

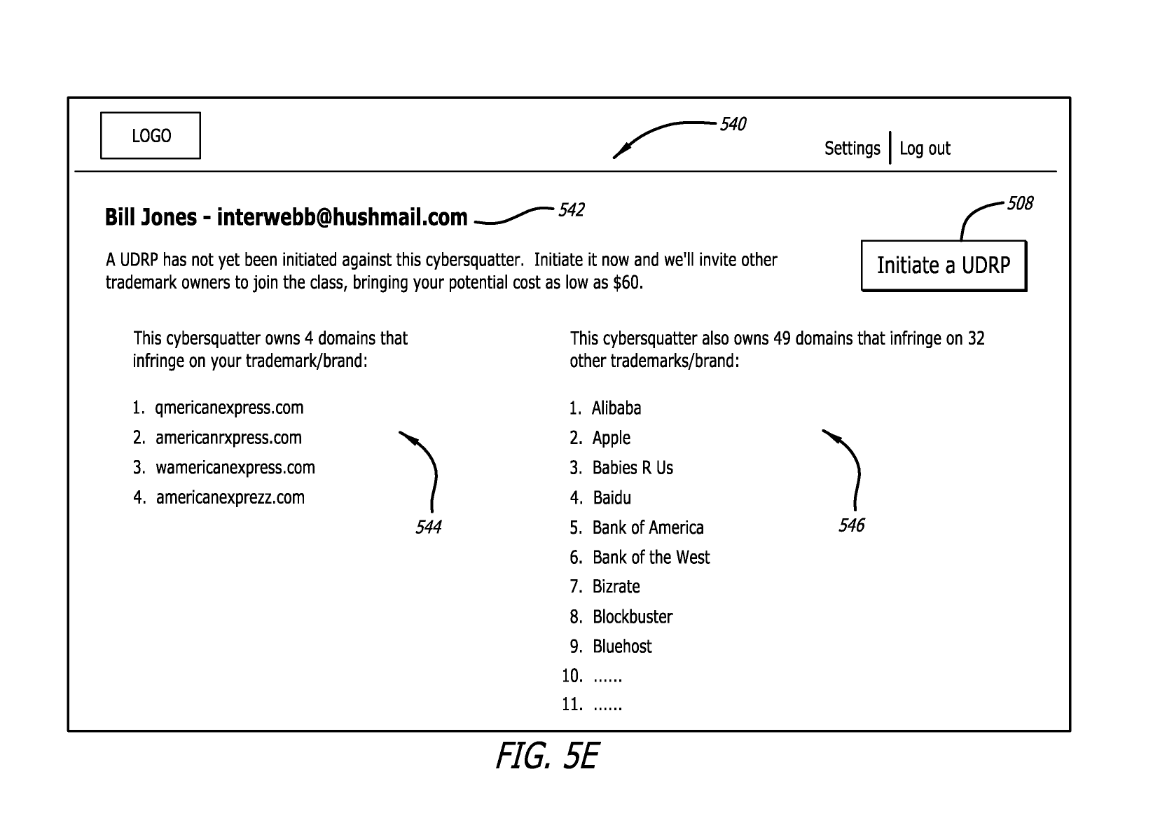

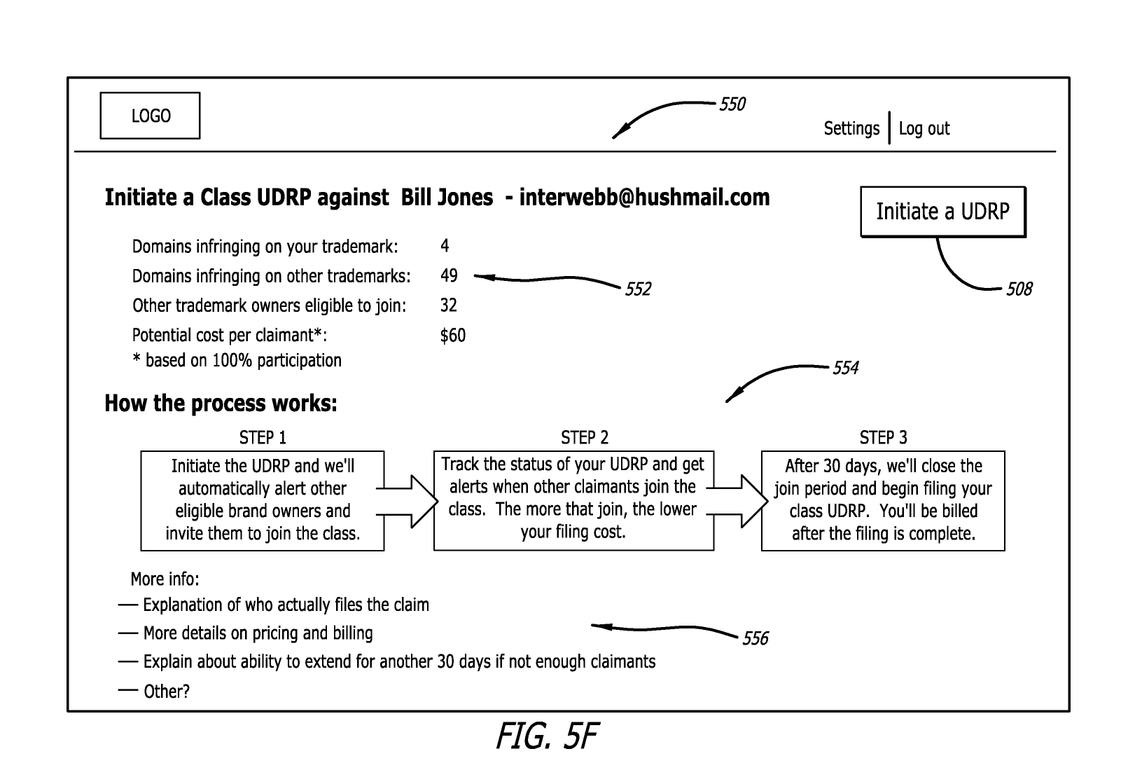

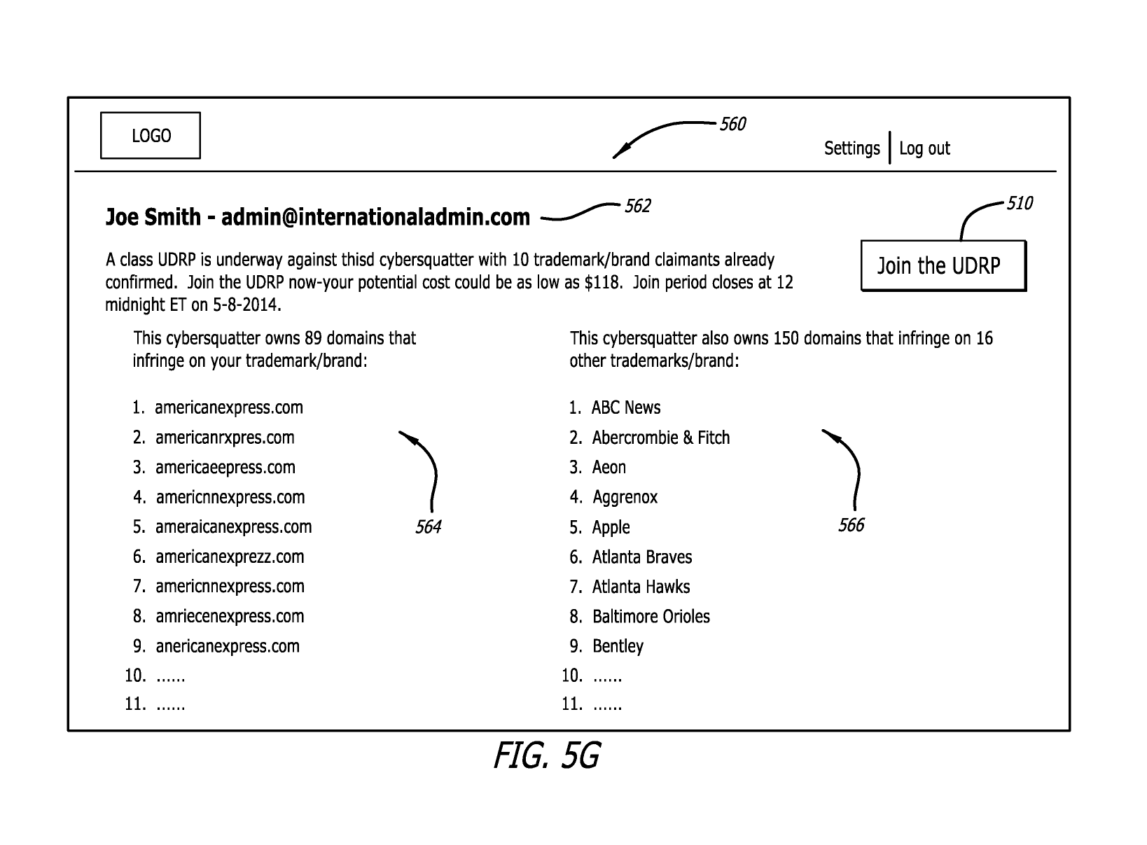

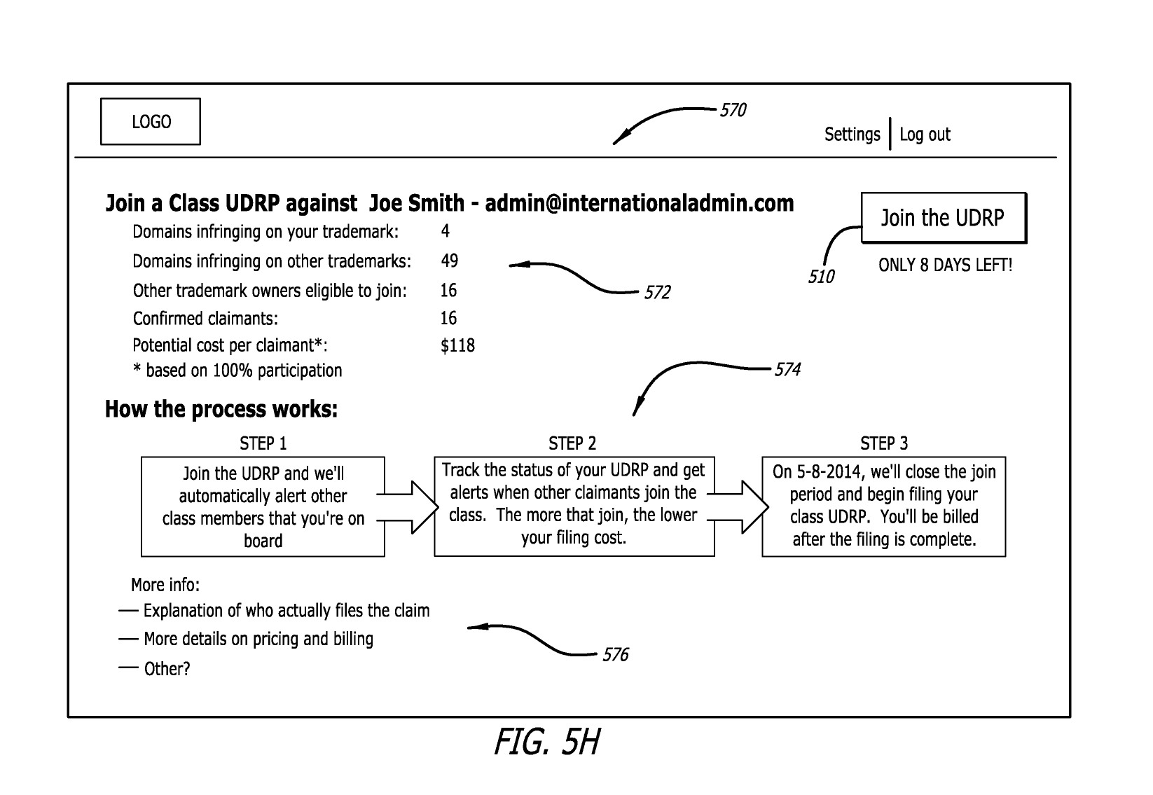

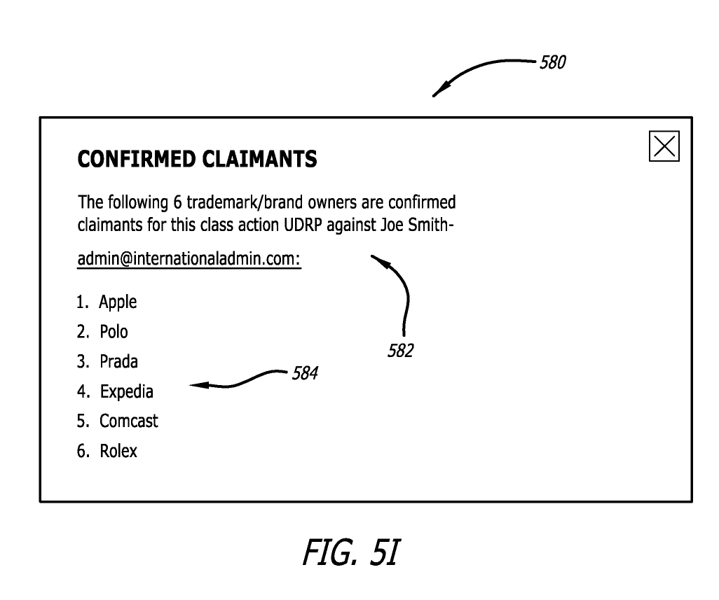

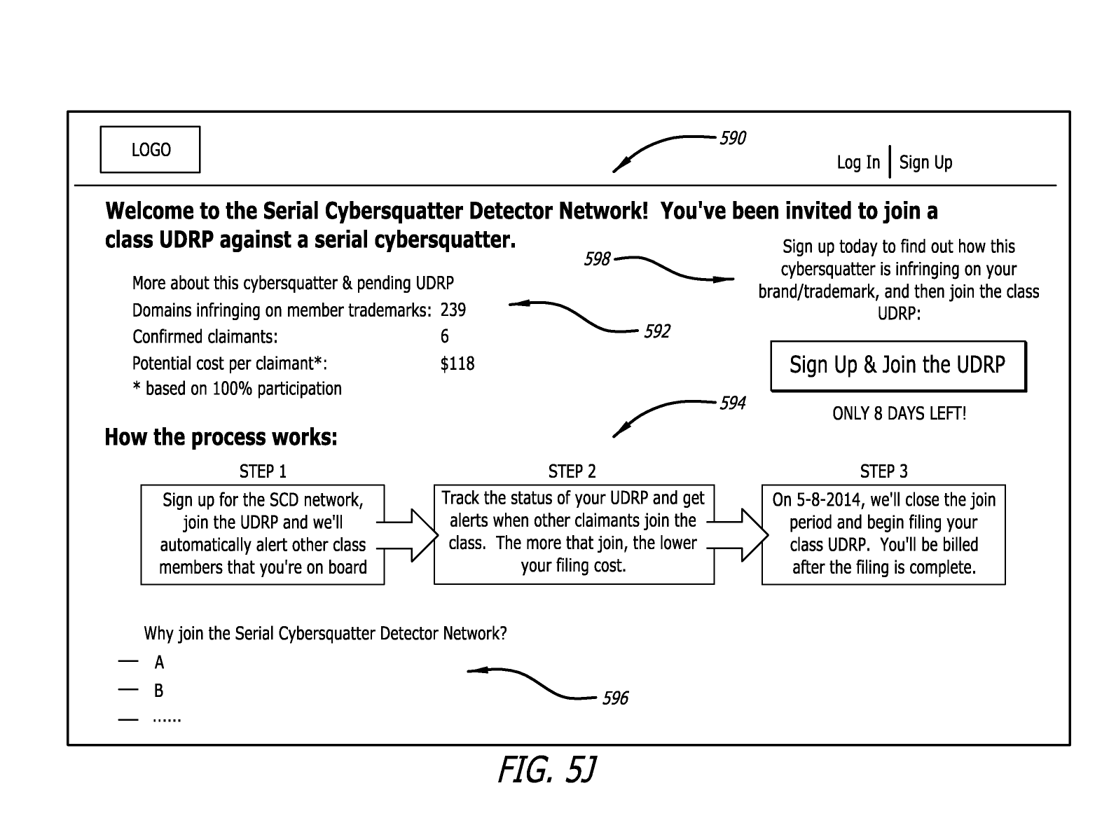

Turning now to FIG. 4, a flowchart is detailed providing the process 400 for creating and implementing an exclusive network of brand owners (and other users) that are able to identify serial cybersquatters, in connection with the capabilities of the detection engine 300, and coordinate with other users to effectuate a class action DRP, as discussed above. Process 400 will be discussed in connection with FIGS. 5A-5J, which depict exemplary screens of a User Interface (UI) for the network 500. As discussed in more detail below, FIGS. 5A-5J detail embodiments for joining/signing in to the network, conducting a search for cybersquatters, identifying potential other uses for a DRP proceeding, and commencing such proceeding, where users will be able to join a class for a new proceeding and/or an existing proceeding.

Process 400 begins with Step 402 with a user accessing the network 500 and being displayed homepage 503, as depicted in FIG. 5A. FIG. 5A contains information that is displayed/available to the user prior to logging in, as in item 501, and information that is displayed/available upon logging in (or joining the network, as in item 502. As discussed in more detail below, network 500 provides the gateway for the user to the capabilities of the detection engine 300 discussed above.

According to some embodiments, the log-in procedure can include, in whole or in part, the user providing certain information for registering interacting with/within the network 500. In some embodiments, this “Registration Information” can generally be grouped into two main categories: (1) Personal Information and (2) Trademark Information. Information that identifies a user as a particular individual can be referred to as “Personal Information.” For example, this can include, but is not limited to, the user's name, mailing address, email address, professional title or position with the trademark holder, and the like. The term “Trademark Information” refers to information concerning brands or trademarks subscribed to the network 500, and the individual or entity that is the owner of such trademarks or brands. Trademark information does not directly identify the user as a specific individual unless the user is the owner of the trademark(s) or brand(s). According to some embodiments, network 500 collects and processes both Personal Information and Trademark Information upon registration (or becoming a member of the network 500). In some embodiments, the network 500 may also collect Personal Information and/or Trademark Information through a variety of other known or to be known methods, including, but not limited to, communications offline, when the user submit/updates Profile Content (defined below) or otherwise interact with/within the network 500.

Certain features of the network 500 are only accessible by members who have registered for the Network and created an account, as discussed in more detail below. For example, a user must first complete a registration form that requests the Registration Information, as discussed above. Thus, in some embodiments, when a user signs up as a member to the network 500, the network 500 can create and/or associate one or more trademarks with the trademark holder you subscribe to the network 500 through your Account (each, a “Trademark Profile”). In some embodiments, the network 500 may also associate additional content with your Trademark Profile based on your interactions with the network 500 on behalf of the trademark holder, such as dispute resolution proceeding (DRP) preferences, the number of proceedings joined or initiated, and other related activities arising from your use of the Network to learn more about serial cybersquatters and potential collaborative opportunities (collectively, “Profile Content”). While Profile Content contains Registration Information related to Trademark Information, it does not contain your Personal Information.

Upon accessing the network 500 (prior to joining or logging in), the user will be presented homepage 503. From homepage 503, the user can either be displayed or provided the ability to view information from screen 501 related to, but not limited to, about/contact us 505, terms and conditions (Ts & Cs) 507, privacy 509, and the like, in addition to some combination thereof (such information can also be displayed on subsequent screens as understood by those of skill in the art). The user can also log in to the network via login item 511. Additionally, from homepage 503, a user can also have the ability to conduct a search in accordance with the detection engine 300 discussion above. That is, a user, prior to logging in or joining the network, may be afforded the ability to conduct a search and view cybersquatter search results 513. After the search results are conducted, in order to delve further into the capabilities of the detection engine 300, the user must either login via item 503a, or sign up via the sign up option 515 to join the network.

Once presented with the sign up screen 515, the user can login or sign up via screen 503a. If the user has an existing account they will be viewed as “verified”; and if not, “unverified” until they establish an account—as provided in item 503a. In some embodiments, being “verified” and/or “unverified” can relate to a user being established to be a true representative of the trademark holding through security protocols such as a handshake with the corporate email address associated with the domain known through public records to belong to the trademark holder. Upon logging in to the network, the user can be presented the information from screen 502 related to, but not limited to, about/contact us 505, terms and conditions (Ts & Cs) 507, privacy 509, and the like, in addition to some combination thereof. Additionally, the user can view, modify and/or monitor his/her account settings 514. As discussed in more detail below, the user can identify and/or determine cybersquatter detail 504 by either 1) initiating UDRP 508 or joining an established UDRP 510, where the user will ultimately become effectively active in the UDRP in item 512. Further, from the homepage 503 (i.e., logging in), the user can check the status of an existing UDRP 506. As discussed in more detail below, checking the status of a UDRP can involve monitoring an ongoing proceeding which the user is involved, sending invitations to other users to join 516, or receiving an invitation 516 for the user to join. Such invitations 516, where the user is requested to join an ongoing or new UDRP, or requesting other users to join a new or ongoing UDRP, and information related to such invitations (which can include but are not limited to, the user, cybersquatter and brands in question, among other UDRP information) can be viewed in screen 517.

As discussed above, the user can be a brand owner or a legal representative of a brand owner. In some embodiments, the user can be any party seeking information about brand management, as discussed above. For purposes of process 400 and the discussion herein, the user will be viewed as a brand owner; however, this should not be construed to limit the applicability to other types of users, as discussed above. Similarly, the display for filing UDRPs should not be construed to limit the applicability to other types of enforcement activities or research, as discussed above.

In Step 404, the user can conduct a search for a brand or trademark. That is, the user can enter a character string (containing text or numerals/digits) related to a brand or trademark the user. The search can contain any characters related to a brand/trademark, as the search can be related to the user's brand/trademark, or another brand/trademark. In some embodiments, the search comprises characters related to a brand/trademark. In some embodiments, the search can include an uploaded image representing the brand, or the actual trademark (should the trademark include certain imagery, as understood by those of skill in the art). As discussed above, the search relates discovering serial cybersquatters who are attempting to “poach” the brands presence in a market. In other words, a search can be commenced to identify cybersquatters that are violating a user's brand or trademark with multiple domains. As illustrated in FIG. 5B, screen 520 depicts a search for the brand “american express”, as indicated by the text entered in the search box 522: “amer”. As understood by those of skill in the art, as the user enters text, the search box can be auto-populated with popular and/or relevant brands that contain the entered text. It should be understood that screen 520 relates to the discussion above to item 513, where the search results 513 are depicted in FIG. 5C, as in Step 406. That is, in Step 406 a search results screen 525 is presented to the user based on the entered text.

From the above example, the search was for the “american express.” For purposes of this discussion, the search is respective a brand; however, it should be understood that should the search have been for the trademark for “american express”, it would follow in a similar manner. Therefore, as depicted in FIG. 5C, result screen 525 can be displayed to the user, where the search results 513 are displayed. For example, the search results 513 can include the number of cybersquatters, the number of domains, and the other information related to similar trademarks. That is, as illustrated in FIG. 5C for example, the information provided indicates item 513, that: there are 53 serial cybersquatters who own one or more domains that infringe the brand for “american express”; there are 189 domains that infringe the trademark for “american express”; and that there are 48 other trademarks also being infringed by each cybersquatter on average. It should be understood that the information displayed respective the search results 513 can include additional or fewer informational data points respective cybersquatters, and need not be in the depicted format and order.

In some embodiments, the search results page provides the user with the ability to sign up 515, as illustrated in FIG. 5C. Indeed, if the user already has an account, the user can simply log in 515a, as discussed above. Signing up or logging in is performed in Step 406. It should be understood that Step 404 (i.e., conducting the search) can be performed after Step 406. That is, embodiments exist where a user would conduct a search after logging in/signing up, as one of skill in the art would understand. Indeed, the search can be conducted in conjunction with the above discussion of the detection engine 300 for identifying serial cybersquatters respective a particular brand or trademark. In some embodiments, a user's action of logging in may also result in the user being brought back to a previous search.

According to some embodiments, as discussed in more detail herein and illustrated in the below Use Cases, the network 500 involves a credit (point or scoring) system that encourages user participation in not only the network, but also participation in UDRPs or other enforcement activities taken collectively or in parallel to reduce costs for the brand holders. That is, when a user signs up for the network's 500 service, they can be awarded credits that enable them to join a default (or predetermined) number of class complaints (e.g., 5 possible suits). When a user initiates a class UDRP, they can be awarded additional credits. When a user joins an existing UDRP, they can also be awarded additional credits. In some embodiments, when a user gains additional credits, that is, a determined number of credits having been accumulated, they are afforded the opportunity to initiate/join other enforcement opportunities. In some embodiments, a particular number of credits may be required to join a class of complainants. This number can be decided on the cost of the UDRP proceeding, costs related to the network 500 costs, and/or costs associated with the brands/trademarks in question. In some embodiments, the credits can also be used to remedy costs for filing, and/or lessen costs for maintaining membership with the service provided by the network 500 (i.e., access to the capabilities provided by the detection engine 300 running on the network 500). In other embodiments, the credits can be used to afford users an opportunity to initiate enforcement opportunities, while concurrently always making available to network members the opportunity to join any initiated enforcement opportunity. This enables brand owners a constantly improving visibility into opportunities that have not yet been initiated while at the same time not limiting their ability to participate in any initiated activity on the network by a member.

After logging in/signing up to the network 500 and conducting the search as in Steps 404-406, the user can then be presented with homepage 503a, as in Step 408. As discussed above, the logged in homepage 503a includes information relevant to the user, including, but not limited to, cybersquatter data summary, pending suits/proceedings, and proceedings available to join. That is, from the homepage 503a, the user will have the ability to initiate a proceeding or join a proceeding, as discussed above respective items 504, 508 and 510. Thus, Step 408 results in the depiction of homepage 503a, as illustrated in FIG. 5D. For example, FIG. 5D provides information regarding the number of brands the user is currently monitoring, item 530; the top cybersquatters identified respective such brands from 530, item 532; and current UDRP proceedings the user is involved in, item 534. The information that can be displayed respective the top serial cybersquatters (item 532) includes, but is not limited to, the registrant or admin-c email address for such cybersquatters (as discussed above respective FIG. 3), the number of domains infringing the user's brand for each registrant or admin-c address, other brands being infringed, the total number of brands the address allegedly infringes, and the UDRP status respective such cybersquatter. In some embodiments, as discussed in more detail below, a time period for joining an existing proceeding can be indicated within item 532. From here, the user can have the ability to initiate a proceeding (item 508) or join a proceeding (510). Additionally, FIG. 5D also provides information regarding the current UDRPs the user is already involved in, item 534. This information includes, but is not limited to, the registrant or admin-c email address for the infringer, and whether, for each case, the status, confirmed claimants (e.g., number of users in the class), unconfirmed complainants (users invited to join the class who have yet to officially join), and the close date for the proceeding (if applicable). Thus, as discussed in more detail below, the user can then, from the homepage 503a initiate or join a UDRP. Step 410.

It should be understood that the screens depicted in FIGS. 5A-5J are for illustration purposes only, and should not be construed to limit the UI of the network 500 to those embodiments displayed. That is, the layout, format and information provided on each screen may vary within the scope provided herein, as the information capabilities and functionality of the network UI and underlying detection engine 300 implemented therein can be enabled and available to a user(s) in many different forms not departing from the scope of the present disclosure.

In connection with the above discussion, FIGS. 5E-5J provide exemplary screens related to initiating or joining a UDRP, as discussed above. FIG. 5E depicts an example of a screen 540 that can be presented to a user upon determining to initiate a UDRP. The screen 540 provides the user with the information relevant to the alleged cybersquatter identified from the search of Step 404 (and from the steps performed by the detection engine 300 from FIG. 3). This screen 540 can be enabled or displayed respective a user action on an item displayed on homepage 503a—for example, clicking on the “initiate” hyperlink displayed within item 532. On screen 540 there is button 508 that enables a user to initiate a UDRP proceeding against the identified cybersquatter. Respective to the identified cybersquatter, information displayed can include, but is not limited to, the registrant or admin-c email address 542 for the cybersquatter, a listing of domains 544 the cybersquatter owns that infringe the user's brand (or the brand entered in the search), and a listing of other domains 546 the cybersquatter owns that infringe on other trademarks/brands (which can be resultant of the user's entered search). The interface can also display a message indicating that other trademark or brand owners could be invited, and the associated reduced cost to the current user should those other entities join the class of aggrieved owners. It should be noted for the record that any mention of specific email addresses of so-called identified cybersquatters are for illustrative purposes only, and not to be taken as an assertion of fact that specific email addresses identify actual cybersquatters. The identified email addresses, for example, may not have been run through whitelists as previously discussed, and therefore have no substantive value, are being used for illustrative purposes only, and should not be taken as accusations against any actual individuals or entities.

Indeed, FIG. 5F displays an embodiment of a screen 550 that can be displayed to the user upon deciding to initiate a UDRP against the identified cybersquatter. Item 552 provides an alternative listing of the information provided in items 542-546 from FIG. 5E. Item 552 also can provide a cost estimate calculation that indicates the cost per claimant for commencing a UDRP against the cybersquatter. That is, the detection engine 300 can perform a calculation based on 1) the number of domains infringing a user's brand/trademark, the number of domains infringing other users' brands/trademarks, and 3) other trademark/brand owners eligible to join a proceeding. As illustrated, such estimate is based upon “100% participation” by all eligible claimants.

FIG. 5F also provides, along with the initiate UDRP button 508, the information 554 for how a proceeding would be commenced through the network 500, in addition to other information links 556 alerting the user to additional information respective such proceeding. For example, as depicted in item 554, the proceeding can be broken down into three steps. Step 1 includes the user initiating the proceeding (by clicking button 508) and the network 500 (via a detection engine 300 implementation) automatically alerting other eligible brands owners to the proceeding by inviting them to join a class (as discussed above and provided for via FIG. 5J in more detail). Step 2 involves the network 500 tracking the status of the commenced UDRP and providing alerts to the user when other claimants join the class (as illustrated in FIG. SI). Step 3 involves the network 500 closing the “join” period for other claimants after a predetermined time/threshold period (e.g., 30 days), and commencing the formalities of the UDRP. According to some embodiments, the period for users to join the suit can be extended, and in some embodiments, such extension can be determined by the system or the lead complainant, as discussed in more detail below. According to some embodiments, billing for initiating a suit occurs after filing, and in some embodiments may occur immediately prior.

FIG. 5G illustrates an embodiment of a screen 560 where a user has the ability to join an existing UDRP. That is, as discussed above respective item 532 from FIG. 5D, screen 560 can be enabled or displayed respective a user action on an item displayed on homepage 503a—for example, clicking on the “In progress—Join!” hyperlink displayed within item 532. The screen 560 provides the user with the information relevant to the alleged cybersquatter identified from the search of Step 404 (and from the steps performed by the detection engine 300 from FIG. 3). On the screen 560 there is button 510 that enables a user to join an existing UDRP proceeding against the identified cybersquatter. Respective the identified cybersquatter, information displayed can include, but is not limited to, the registrant or admin-c email address 562 for the cybersquatter, a listing of domains 564 the cybersquatter owns that infringe the user's brand (or the brand entered in the search), and a listing of other domains 566 the cybersquatter owns that infringe on other trademarks/brands (which can be resultant of the user's entered search). Indeed, item 562 can also include information indicating that a class UDRP is already underway, the number of claimants already having joined the class, the price to currently join (based on the number of claimants currently involved in the class), and the time period for joining (e.g., when the joining period expires.

FIG. 5H displays an embodiment of a screen 570 that can be displayed to the user upon deciding to join a UDRP against the identified cybersquatter. Item 572 provides a listing of the information provided in items 562-566 from FIG. 5G. Item 572 also can provide a cost estimate calculation that indicates the cost per claimant for joining the UDRP, similar to above the discussion of the cost estimate. FIG. 5H also provides, along with the initiate UDRP button 510, the information 574 for how a proceeding would be commenced through the network 500, in addition to other information links 576 alerting the user to additional information respective such proceeding. For example, as depicted in item 574, the proceeding can be broken down into three steps. Step 1 includes the user joining the proceeding (by clicking button 510) and the network 500 (via a detection engine 300 implementation) automatically alerting other brands owners eligible to join the class to the user's participation. Step 2 involves the network 500 tracking the status of the commenced UDRP and providing alerts to the user when other claimants join the class (as illustrated in FIG. SI). Step 3 involves the network 500 closing the “join” period after a predetermined time/threshold period (or on a specific date), and commencing the formalities of the UDRP. It should be noted that rather than having a predetermined window of opportunity for joining an enforcement activity such as a UDRP, the window may be tied to the preferences of the users involved, such as on average how long it has taken to gain adequate participation according to the preferences of the person that initiated the proceeding in the past, or their pre-indicated preference. According to some embodiments, billing for initiating a suit occurs after filing, and in some embodiments may occur immediately prior.

FIG. 5I illustrates an example screen 580 that provides an indication of confirmed claimants who have joined a class UDRP proceeding against a cybersquatter. The information displayed in the screen 580 involves the identified cybersquatter 582, and a listing the participating claimants 584. In some embodiments, screen 580 can be displayed upon the join/initiate period expiring, or upon confirmation of each individual claimant. In some embodiments, the screen 580 may only be displayed after a predetermined number of claimants join. In some embodiments, the screen may be displayed as a pop-up window, where embodiments exist where such screen 580 is only available upon the user having logged into the network 500. In some embodiments, the information provided in screen 580 may be provided to the user via a message, such as but not limited to, an email, SMS/MMS message, social networking message, and the like.

FIG. 5J illustrates example screen 590 which illustrates an exemplary embodiment of a user receiving an invitation 516 network 500 (referred to as the “Serial Cybersquatter Detector Network” or “SCD”). In some embodiments the invitation 516 to join can be automatically triggered by the network 500 determining that a threshold amount of infringing activity is occurring respective a particular brand/trademark, which can be based upon an separate individual search, previous and/or current searches, new and/or existing UDRP proceedings, or some combination thereof. Upon receiving the invitation 516, the user can join, via item 517 discussed above. That is, the screen 590 produced from an invitation 517 includes information on how and by whom a user's brand/trademark is being infringed, and what steps the user can take to not only join the network 500, but also partake in a proceeding to prevent further infringement. Item 592 provides a listing of the information respective a cybersquatter—related to the invited user's brand(s), and other potential brands in the potential class (similar to the discussion above). Item 592 also can provide a cost estimate calculation that indicates the cost per claimant for joining the UDRP, similar to above the discussion of the cost estimate. FIG. 5J also provides, along with the “sign up & join the UDRP” button 598 (which correlates with the above discussion respective items 510 and 515), the information 594 for how a proceeding would be commenced through the network 500, in addition to other information 596 regarding why joining the network would be beneficial to the user. Such information 596 can include, but is not limited to, past results from previous proceedings, user testimonials, and the like. Further, for example, as depicted in item 594, the proceeding can be broken down into three steps. Step 1 includes the user joining the network 500 and the UDRP (by clicking button 598) and the network 500 automatically alerting other brands owners to the user's participation. Step 2 involves the network 500 tracking the status of the commenced UDRP and providing alerts to the user when other claimants join the class (as illustrated in FIG. 5I). Step 3 involves the network 500 closing the “join” period after a predetermined time/threshold period (or on a specific date), and commencing the formalities of the UDRP. According to some embodiments, billing for initiating a suit occurs after filing, and in some embodiments may occur immediately prior.

Therefore, as described via the above discussion of FIG. 4 and FIGS. 5A-5J, network 500 is an exclusive network of brand owners, which allows users to join other users in effectuating a class UDRP suit against identified cybersquatters. The network 500 involves the identification of the cybersquatters through implementation of the detection engine 300, as discussed above, and the social aspects of the network 500 which enable users to not only initiate and join UDRP suits, but also allow uses to invite other users to join the network 500 in order to protect their brand. As discussed previously, network 500 works not only for initiating UDRPs for reclaiming domains, but also for compelling privacy or proxy registration providers to either unmask the identity of the underlying registrants, who in turn may be broken down into multiple parallel class complaints, or for the proceeding to continue against the privacy or proxy registration service provider; in other situations, it may be enough to have cost-effectively unmasked the privacy or proxy registration to provide the underlying contact details of abusive domains being used for, for example, rogue Internet pharmacies, phishing schemes, or advance fee fraud—even without being able to continue in the proceeding to have the domain names transferred via UDRP. As also discussed previously, network 500 works for sharing the cost of Reverse Whois Lookup Reports to audit the complete currently and/or historical domain name portfolio of identified target serial cybersquatters. As also discussed previously, parts of network 500 work for collaborative opportunities such as proceeding in parallel with other brand holders in trademark infringement lawsuits, or for even a single brand holder to gather evidence of bad faith and proceed independently.

Further to the above discussion, below is a breakdown of exemplary features of the network 500, using a class UDRP complaint as an illustration, further describing the capabilities and functionalities discussed above respective FIG. 4 and FIGS. 5A-J. Such capabilities and functionalities are implemented through the user experience illustrated in FIGS. 5A-J, and the features highlighted below. It should be understood that the features and capabilities included in the tables below are not to be construed as limiting, as they are example capabilities within the scope of the present disclosure.

For example, according to some embodiments, regarding a brand/trademark owner, such capabilities include:

| | |
|---|---|
| Trademark | Logged out user can search for their brand trademark |
| match | and match it to one already in a network database |
| | (which can be compiled in real-time or pre-loaded). |
| No | If the user cannot find their brand trademark on the |
| trademark | website, they can go to a form where they can fill out a |
| match | request to have their trademark added. |
| Trademark | Logged out user can view the cybersquatter results |
| search | found in the database for that particular trademark. |
| results | Results initially are “masked”, showing only aggregate |
| (masked) | data such as: |

# of serial cybersquatters identified
# of trademark domains for that brand held by
identified cybersquatters versus all brands
# of other trademarks that cybersquatter is violating.

| | |
|---|---|
| | In no search results are found, they can go to a form |
| | where they can fill out a request to have their trademark |
| | added. |
| Sign up | User can sign up and create an account, which can |
| | include: |

Org name
Trademarked brands owned
first name
last name
title
email address (corporate)
mailing address
password
contact telephone
T&C agreement
payment terms

| | |
|---|---|
| Welcome email | After verification is complete, user receives an email |
| | welcoming them with further instructions on how to get |
| | started |
| View detailed | Logged in user can see detailed information by |
| results by | trademark for up to 5 possible class complaints at a time |
| trademark | (unless they have earned points to see more either by |
| | becoming a lead complainant or joining a pending |
| | UDRP): |

Name of cybersquatter
indicator if cybersquatter is already part of a class
suit (status: in process; filed)
# of violations by that squatter for user's trademark
list of domains that violate user's trademark
# of other trademarks violated by that squatter
sample of names of other trademarks violated by
that squatter (company names or logos, or both)

| | |
|---|---|
| Display top | Logged in user is shown a list of at least 5 UDRP |
| 5-7 | opportunities that the service has identified. |
| opportunities | List is ranked in descending order by # of domain |
| (non-initiated) | violations that cybersquatter has against the user. |
| | Second ranking criteria is the number of other brands |
| | that the cybersquatter is infringing upon. |
| | The maximum number of opportunities a user can see is |
| | 7, which is the typical five plus two more which they |
| | earn through initiating a UDRP. Or they can earn 1 point |
| | when they join a UDRP which would yield 6 results, or |
| | even 7 if they join 2 claims. |
| | The minimum number of opportunities to show is 1. |
| | If no opportunities have been identified, that should be |
| | messaged in the UI. |
| Display suits | Logged in user is shown a list of any and all initiated |
| to join | UDRP suits that they are eligible to join. |
| | There is no limit to the number of claims that can be |
| | displayed. |
| | If there are no claims for that user to join, this portion of |
| | the UI is hidden. |
| Initiate or | User can initiate or join a class suit against a serial |
| join a class | cybersquatter. Upon initiation, they are classified as the |
| suit | class suit “lead” or first complainant or as a member of |
| | the class if it has already been initiated. |
| Class suit | Present user initiating class action with details re: the |
| details | suit such as: |

other trademarks that are eligible to become
members or are existing members and eligible to
join the suit
Potential cost of suit (range based on number of
participating trademarks).
Outline of process and steps to filing the class suit
Messaging about points incentive (earn 2 when they
initiate which gives them access to more data)

| | |
|---|---|
| 30 day | The network sets an automatic 30 day deadline by which |
| participation | the other trademark holders must join in. |
| deadline | If nobody else has joined the claim after 30 days, the |
| | lead can extend the deadline by an additional 30 days |
| Automatically | After initiating, existing members that can be part of the |
| invite other | claim are automatically invited via email to join the |
| trademarks to | UDRP. |
| participate | |
| in suit | |
| Prompt to | In the event that there are trademarks in the UDRP that |
| invite non- | have not yet been claimed on the network, we can |
| members | encourage the claim initiator to send a join request |
| | manually via email if they know someone that |
| | represents said trademark. |
| View status | After the suit is initiated, user can view status details: |
| of class suit | If before the deadline: |

upcoming deadline
# of confirmed participants
current cost of suit (cost/# of participants)

If after the deadline:

date closed
# of participants
final cost of suit
Anticipated filing date (deadline + x days)
Notes from filing (these are notes that can be added,
date and time stamped)

| | |
|---|---|
| Re-notify | If deadline is still in the future and there are invitees that |
| non-responding | have not yet joined the suit, the system will re-invite |
| trademarks | members every week until the 30 day window is closed. |
| | In some embodiments: If there are eligible members that |
| | have not yet joined, a lead or another eligible member |
| | that is already a member of the system can “poke” the |
| | others to join and an email will go out as well saying |
| | they are being poked to join by whichever member is |
| | poking them. |
| Join a class suit | During the search process, it's possible that their |
| | trademarks are part of pending class suits that are still |
| | open. User should have the ability to view the details of |
| | these suits (like the invitee user experience) and join as |
| | the trademark holder. Any time that a member is |
| | eligible to join, they will see that opportunity as one of |
| | their five opportunities or as an additional one. |

It should be understood from the above table, and the tables below, that the specific numbers for UDRP opportunities, the time period, credits earned, verification period, and the like are for example only, and should not be construed to limit the present disclosure to particular embodiments of such. Indeed, further description of this and the varying alternative embodiments can also be seen in the Use Cases discussed below.

According to another non-limiting example, according to some embodiments, regarding an invited user to join a suit (e.g., invitee), such capabilities include:

| | |
|---|---|
| Suit summary - | After clicking from invite email, user can see masked |
| masked (join | details about suit for which they were invited to join: |

| | |
|---|---|
| period is | Primary claimant trademark & user name |
| still open) | Confirmed participants - company name and/or logo |
| | # pending participants |
| | potential cost range for class suit participation |
| | deadline to join |

| | |
|---|---|
| Suit summary - | After clicking from invite email, user can see masked |
| masked (join | details about suit for which they were invited to join: |
| period is | “Sorry, this class suit has already been filed!” message |

| | |
|---|---|
| closed) | # confirmed participants |
| | deadline date |
| | prompt to find other suits to join |

| | |
|---|---|
| Join suit - | User can sign up and create an account, which includes: |

| | |
|---|---|
| Sign up | Org name |
| | Trademarked brands owned |
| | first name |
| | last name |
| | title |
| | email address (corporate) |
| | mailing address |
| | password |
| | contact telephone |
| | T&C agreement |
| | payment terms |

| | |
|---|---|
| Confirmation | User receives email confirmation and on-site recognition |
| of suit join | of participation in the class suit |

In another non-limiting example, according to some embodiments, regarding a global aspects of the network 500, such capabilities include:

| | |
|---|---|
| Log in | User can log in with their email and password |
| Log out | User can log out of the website |
| Account | User can change their account information on the |
| information | website |
| update | name* |
| | email address |
| | mailing address |
| | contact phone |
| | password |
| | For example, in the event a legal representative |
| | leaves the company, this gives them the ability to |
| | effectively transfer the account to another colleague |

In yet another example, according to some embodiments, regarding internal tools and features of the network 500, such capabilities include:

| | |
|---|---|
| Trademark | The network, and/or team members hosting the network |
| holder | can verify that the registrant is an authorized |
| verification | representative of said trademark. In some embodiments, |
| | this can be confirmed via email ID (e.g. corporate email |
| | domain), via phone or other methods TBD. |
| Account | If user cannot be verified as an eligible trademark |
| rejection | holder, the account should be rejected and the trademark |
| (verification | can go back into the pool for claim. |
| fail) | |
| Account | After verifying a trademark holder, and payment if any |
| activation | is received, the account is activated, which triggers a |
| | welcome email to the user. |
| Reports - | # of accounts created |
| key metrics | # of accounts verified |
| | # class suits initiated (and still open) |
| | # of class suits in process (closed and in filing) |
| | # invites sent |
| | Revenue from signups |
| | # of domains included in suits (closed and in filing) |
| Brand/ | Database containing brand keywords and trademarks |
| trademark | that are included in, or affiliated with the network. These |
| database | can be added or removed. |
| Brand monitor | Key terms that are used when matching domains with |
| database | trademarks, such as wwwd, wwwc, etc. These can be |
| | added or removed. |
| Whitelist | Database of exempted email addresses of domain |
| database | owners. Domains owned by these email addresses will |
| | not appear in any search results. These can be added or |
| | removed. |

By way of a non-limiting example, according to some embodiments, known or to be known third parties that can be integrated into or along with the network 500:

| | |
|---|---|
| Domaintools ® | Integration with domaintools.com API to pull in data |
| | about serial cybersquatters including domain and Whois |
| | Lookup information, Reverse Whois Lookup hit counts |
| | per identified potential cybersquatter, Brand Monitor |
| | API to retrieve and score request typos such as |
| | (wwwa . . . wwwz etc.), Typosquatting API to retrieve |
| | typosquats of brands in the brand engine |
| Linkedin ® | Integration with Linkedin API or other social network |
| | API to find contact information for class suit invitees |

Furthermore, according to some embodiments, communications such as emails (and the like) provide the following user experience, for example:

| | |
|---|---|
| Thanks for | After user signs up, send email thanking them and |
| signing up | confirming next steps (verification within 1 business |
| | day). |
| verification | Confirming that they are now the verified owner of X |
| complete | trademark on the network. Prompt them to come in and |
| | use the site. |
| Account | If the network can not properly verify the claim to a |
| rejection | trademark, user receives email confirming that their |
| | account could not be created. In some embodiments, the |
| | action involves the user contacting the network or re- |
| | applying with more complete information. |
| class suit | Confirm that suit has been initiated and include details |
| initiated | such as deadline, remind them to invite participants, |
| confirmation | outline next steps. |
| New member | Suit initiator receives a notification email each time a |
| joined claim | new trademark joins the claim. |
| invite to | Email to member asking them to join a class suit that |
| join class suit | has been initiated. |
| re-invite to | Very similar to initial invite email, but this is sent in |
| join class suit | weeks 2, 3, and 4 if member has not yet joined the |
| | claim. (As discussed above, these times are for example, |
| | and can vary with particulars of a suit or a user, and/or |
| | particulars of particular brands or cybersquatters). |
| class suit | Confirmation that class suit join period has ended and |
| closed; filing | that the network will begin filing the class suit. |
| next steps | |
| account update | Confirm that changes were made to their account. |
| confirmation | |

Use Cases

By way of some non-limiting examples, in connection with the above discussion, discussed below are example use cases illustrating benefits of the disclosed systems and methods. That is, the use cases discussed below depict non-limiting embodiments of the disclosed systems and methods which provide brand owners the ability to confront and disarm serial cybersquatters.

Use Case 1: Trademark/Brand Owner

John is a lawyer for Abercrombie & Fitch® (http://www.abercrombie.com), a major apparel retailer in the United States. John's primary duty as a member of the legal team is to protect the corporation's trademark and brand, which includes identifying alternate domains that people have purchased that infringe upon the Abercrombie trademark. Examples may include slight misspellings of the trademark (abercrommbie.com) or slight variations (wwwabercrombie.com). Usually, John hears about violations through other team members or through research/alerts that he or his paralegal may get from a monitoring website, such as DomainTools.com. Through such conventional systems, John and his team can identify potential targets; however, the process can be inefficient and as detailed above, costly when identifying single violations at a time.

John learns about a new service, e.g., the network 500—referred as Serial Cybersquatter Detector or SCD. He is can join the SCD network 500 and learn whether there are opportunities to collaborate with other trademark/brand owners against serial cybersquatters. John logs on to the SCD network 500 website and quickly looks up his trademark (Abercrombi®) to see if it's already represented in the system. The website tells him that they have found 24 serial cybersquatters that infringe on the Abercrombie trademark. In addition, the results state that there are 48 other trademarks/brands that are also infringed upon by those cybersquatters, and that John could potentially team up with them to take legal action via a class UDRP complaint.

John agrees to claim his trademark by signing up for the service and agreeing to pay a subscription. With his subscription, he will have access to initiate up to 5 class UDRP opportunities and the ability to initiate a class action suit with other trademark holders. Furthermore, he will have access to join any UDRP initiated by a network member based on the customized top 5 class UDRP opportunities presented to each network member (Note, in addition to the above discussion, embodiments exist where signing up for the network 500 involves a subscription fee which includes, among other features discussed above, access to a predetermined number of UDRP opportunities.)

John proceeds to create his account, which includes providing his name, email, phone, new password, plus any additional brands he wants to put into the system that are also owned by Abercrombie, and agreeing to the service Terms & Conditions. He also agrees to a subscription agreement with payment terms. In some embodiments, John may be presented a “thank you” screen that tells him that he will receive an email once his account is verified. In some embodiments, if a user is signing up in-person, the verification can be done on the spot.

Either immediately (e.g., in person) or within 1 business day of signing up online, John receives an email welcoming him to the SCD network 500. He clicks the link in the email, logs in, and is taken to a personalized homepage where he can see more details about the search results for Abercrombie. He sees a list of the top 5 class complaint opportunities flagged by the name of a serial cybersquatter, and the specific domains that the system flagged as being eligible for Abercrombie to enforce against. The system will also show the other brands/companies that are eligible to participate so that he can reach out to them and encourage them to join.

John identifies “Isaac Goldstein” from the search results, a serial cybersquatter who owns “bercrombie.com”, along with 13 other domains that infringe upon Ed Hardy®, Nokia®, New York Times®, Sony Ericcson®, Monster® and others. John decides that he wants to initiate a class action suit against Isaac Goldstein. John clicks the “Initiate” a class complaint button. During this step, he sees details on how the process will be facilitated by the network 500, including the step in which all eligible brands who are already in the network 500 will be automatically notified that they have 30 days to join the class and how much the addition of each network member on the suit will reduce the cost. John is also informed that as lead complainant on the UDRP, he will earn 2 points, which result in him seeing 7 top class complaint opportunities flagged by the name of the serial cybersquatter (rather than the standard 5). That is, according to some embodiments, as discussed herein, upon initiating a suit as the lead complainant, additional credits can be earned which increases the number of UDRP opportunities.

Once John completes initiation of the UDRP, all registered members will get an email notification of the opportunity (and, in some embodiments, notifications can be sent every week (or according to another predetermined period) thereafter until the 30 day join window closes). When John initiated his UDRP, there were several brands that were not yet registered with the SCD network 500. As a result, he will receive a separate email, encouraging him to tap into his legal network and if he knows the legal representatives of any of the companies listed, he can forward them a link to the UDRP on the SCD site and encourage them to join.

Continuing with the example, according to some embodiments, John receives an email notification each time another trademark holder/brand owner joins the suit. Once the deadline is reached, John receives an email from the network 500 with an update on the filing and next steps, including possibly extending the deadline for an additional 30 days if no others members have joined yet.

Use Case 2: Invitee

Beth is a lawyer for Ed Hardy® (http://edhardyshop.com/), a major apparel retailer in the United States. Her primary duty as a member of the legal team is to protect the corporation's trademark and brand, which includes identifying alternate domains that people have purchased that infringe upon the Ed Hardy trademark. Examples may include slight misspellings of the trademark (edhardey.com) or slight variations (wwwedhardyshop.com).

At the International Trademark Association annual meeting (INTA), Beth is given a card with an invitation to join the SCD network 500 by John, another lawyer at the conference who represents Abercrombie & Fitch. (As discussed above, the invitation can be in person, or via a message—item 516 and FIG. 5J). John tells her about the SCD network 500 and says that she should get her brand(s) registered so she can start collaborating with him on a claim, and other brand holders.

As discussed above, the SCD network provides her the service to protect her brand, in addition to saving her time and money. Beth arrives at the website of the network 500: for example: serialcyberquatterdetector.org. Upon signing up, Beth will have the same experience as John discussed in Use Case 1 above, except that after she signs up, she will automatically see the UDRP that John initiated, which she can join, along with 5 other opportunities. Beth clicks on the pending suit that John initiated and sees more detail about it including which trademarks are participating and which ones are still pending, and the approaching deadline. The page also explains the process and potential costs. Beth decides she wants to participate in the suit so she clicks on the “Join” class suit button. This takes her to a page where she can sign up to join the class the way that John did, as discussed above. During that process, she learns that joining the suit will earn her an additional point on her account, which will unlock an additional opportunity for a UDRP class action (6 instead of the typical 5). That is, according to some embodiments, joining an existing suit can increase the number of UDRP opportunities provided to the user upon signing up for the network 500.

In addition to the above disclose, in some embodiments, network 500 can include additional features. That is, in accordance with some embodiments, the network 500 can include an add-on feature whereby a brand holder can press a button adjacent to any identified Serial Cybersquatter Target infringing on their brand called—the button may be labeled: “Initiate Full Scan”. Therefore, anytime a user/member orders a Full Scan, the network 500 can use Reverse Whois® (RWI) API from DomainTools® to get a full RWI report. Such report could then be reviewed (either automatically or manually, depending on the nature of the report) for identical or confusingly similar domains to the brands owned by the network member that placed the order. Therefore, the user is provided with a limited reverse RWI result which is based on a full review of the domain portfolio. Such embodiments could involve the calculations of the cost for the Full Scan and display a message “The cost for running a Full Scan is currently $ ______. By inviting other brands in the Network that are eligible to participate in a Class Complaint against Target ______ to join you in running the Full Scan, your cost may go down to $ ______. Do you want to invite others to run a Full Scan?”. As a result of such messaging, for example, if the user responds in the affirmative (e.g., says “yes”), then, in some embodiments, a message could go out to network members that are eligible to participate in a Class Complaint: “Target 1 currently has domains that are identical or confusingly similar to your Brand ______. Brand x invites you to run a full scan against Target 1. If you were to run this Full Scan yourself, it would cost $ ______. If all invitees participate, the cost to run the Full Scan may go down to $ ______ per participant. Are you interested in participating in running a Full Scan to find out all the domains in Target 1's possession that are identical or confusingly similar to your brand?” It should be understood that the length, context and types of statements and questions in the above messages should not be construed as limiting, as similar messages may be triggered having a similar context but with different text for relaying the message from the network to the user, such as related to identifying rogue online Internet pharmacies, advance free fraudsters, or information helpful to identify networks or people behind fraudulent phishing schemes. It should also be understood that the “______” (underscore) is not limiting and simply references that appropriate/calculated number (or text) can be input to represent the appropriate figures associated with each message.

Based on the number of eligible class members that expressed interest in running the Full Scan, such users of the class could be messaged after a certain number of days that the cost per participant would be a particular cost, assuming everyone that has initially expressed interest participates. Such users could be asked if they are still interested in participating. There would be a Yes or No selection, but if they select Yes, there will be an opt-in to “Only if the number of participants brings the cost down below: $ ______ per participant”, whereby the network would then provide buttons to choose one from with various calculated dollar amounts that reflect a certain percentage saved from pricing had they gone at it alone. The system discussed herein could then recalculate the price for running the Full Scan per the number of participants that are still interested in running it, taking into account the minimum threshold pricing options expressed by participants, and whether that minimum threshold can be met. The system, according to some embodiments, could message them either a congratulatory message that a Full Scan is being processed, or that we regret there was not enough participants interested in the full scan to meet their pricing demands at this time, but will let them know in the future if any other network member invites them to run a Full Scan.

For the participants in the Full Scan, such users would be able to see identical or confusingly similar domains to their brand, but not the complete reverse RWI report. If it is determined that there are brands in the RWI report that are not members of the network, they would be invited to join the network 500. Participants in the full scan could also be asked upon seeing the results, for example: “Do you want to be alerted if Target 1 registers any additional identical or confusingly similar domains to your brands in the Network?” If such users select yes, then using the registrant alert API, the network could then alert them of newly registered domains by the registrant.

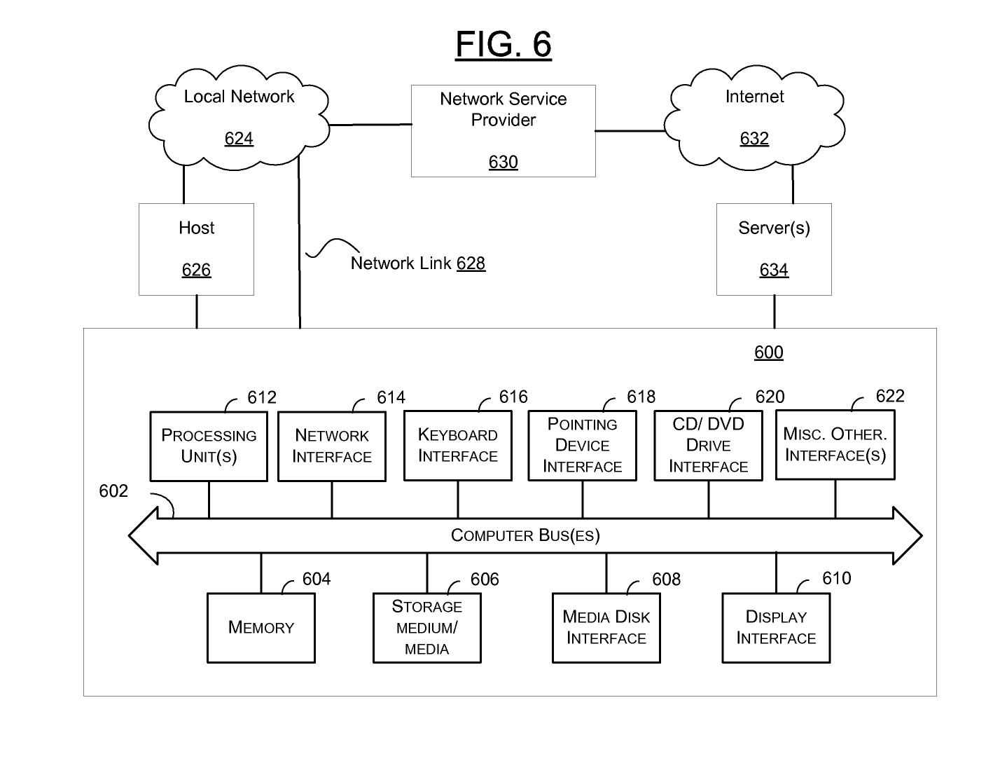

As shown in FIG. 6, internal architecture 600 includes one or more processing units, processors, or processing cores, (also referred to herein as CPUs) 612, which interface with at least one computer bus 602. Also interfacing with computer bus 602 are computer-readable medium, or media, 606, network interface 614, memory 604, e.g., random access memory (RAM), run-time transient memory, read only memory (ROM), media disk drive interface 620 as an interface for a drive that can read and/or write to media including removable media such as floppy, CD-ROM, DVD, media, display interface 610 as interface for a monitor or other display device, keyboard interface 616 as interface for a keyboard, pointing device interface 618 as an interface for a mouse or other pointing device, and miscellaneous other interfaces not shown individually, such as parallel and serial port interfaces and a universal serial bus (USB) interface.

Memory 604 interfaces with computer bus 602 so as to provide information stored in memory 604 to CPU 612 during execution of software programs such as an operating system, application programs, device drivers, and software modules that comprise program code, and/or computer executable process steps, incorporating functionality described herein, e.g., one or more of process flows described herein. CPU 612 first loads computer executable process steps from storage, e.g., memory 604, computer readable storage medium/media 606, removable media drive, and/or other storage device. CPU 612 can then execute the stored process steps in order to execute the loaded computer-executable process steps. Stored data, e.g., data stored by a storage device, can be accessed by CPU 612 during the execution of computer-executable process steps.

Persistent storage, e.g., medium/media 606, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 628 typically provides information communication using transmission media through one or more networks to other devices that use or process the information. For example, network link 628 may provide a connection through local network 624 to a host computer 626 or to equipment operated by a Network or Internet Service Provider (ISP) 630. ISP equipment in turn provides data communication services through the public, worldwide packet-switching communication network of networks now commonly referred to as the Internet 632.

A computer called a server host 634 connected to the Internet 632 hosts a process that provides a service in response to information received over the Internet 632. For example, server host 634 hosts a process that provides information representing video data for presentation at display 610. It is contemplated that the components of system 600 can be deployed in various configurations within other computer systems, e.g., host and server.

At least some embodiments of the present disclosure are related to the use of computer system 600 for implementing some or all of the techniques described herein. According to one embodiment, those techniques are performed by computer system 600 in response to processing unit 612 executing one or more sequences of one or more processor instructions contained in memory 604. Such instructions, also called computer instructions, software and program code, may be read into memory 604 from another computer-readable medium 606 such as storage device or network link. Execution of the sequences of instructions contained in memory 604 causes processing unit 612 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 600. Computer system 600 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 602 as it is received, or may be stored in memory 604 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
enabling, via a computing device, a first user access to a network service, said network service providing access to information associated with a plurality of brands and a plurality of domain registrants or providers of privacy or proxy registration services;
receiving, at the computing device, a search query comprising a character string from said first user, said character string comprising identifying information corresponding to a first brand from said at least one of said plurality of brands;
determining based on the search query, via the computing device, a first domain registrant or provider of proxy or privacy registration services for an Internet domain name that is identical or confusingly similar to the first brand, said determining comprising identifying serial cybersquatting information related to the first domain registrant or provider of privacy or proxy registration services;
storing said serial cybersquatting information in a database associated with said network service;
determining, via the computing device, existence data concerning the existence of a right's holder opportunity to learn more information concerning the right to invoke, or opportunity to actually invoke, legal rights against the first domain name registrant or provider of privacy or proxy registration services via a domain name dispute, the existence data comprising an indication of whether said domain name dispute is in progress and eligible to be joined or shared, or does not yet exist;
if said existence data indicates the domain name dispute is in progress and eligible to be joined or shared, sending information to the first user inviting said first user to join or share in the opportunity;
if said existence data indicates no opportunity yet exists, sending information to the first user inviting the first user to initiate said domain name dispute; and
receiving, at the computing device, an action request from said first user based on said serial cybersquatting information and said existence data.

2. The method of claim 1, further comprising:
initiating the domain name dispute in accordance with the action request from the first user.

3. The method of claim 1, wherein said first cybersquatter information comprises information identifying the first cybersquatter, a number of domains associated with the first cybersquatter that correspond to the first brand, and serial cybersquatting information associated with the first cybersquatter that correspond to at least one other brand.

4. The method of claim 1, wherein said indication that the in progress domain name dispute is eligible to be joined comprises a time period for said first user to join or share prior to initiating said domain name dispute.

5. The method of claim 2, further comprising:
communicating an indication to a second user that said first user has initiated an opportunity in the domain name dispute, said second user associated with a second brand among said plurality of brands, said second user responsible for joining or sharing said domain name dispute against said first cybersquatter, wherein said first user and said second user share costs of said opportunity.

6. The method of claim 2, wherein when said first user initiates said domain name dispute, said initiation further comprises:
receiving, from said first user, an invitation for a second user to join said domain name dispute, said second user associated with a second brand from said plurality of brands;
communicating said invitation to said second user; and
receiving a second user action indicating an intent to join or share in said domain name dispute, wherein said first user and second user share in costs of said opportunity.

7. The method of claim 6, further comprising automatically alerting other brands that serial cybersquatting information exists in relation to said other brands that arises from substantially the same rights that gives rise to the domain name dispute.

8. The method of claim 1, wherein said character string information comprises text of a trademark of said brand.

9. The method of claim 1, further comprising:
determining that said first cybersquatter registered a term identical or confusingly similar to said brand of the first user based on information stored in the database associated with said network service, said database comprising record information comprising data indicating a portfolio size of said first cybersquatter and each registered domain within said portfolio.

10. The method of claim 9, wherein said record information is based upon information provided directly or indirectly via third party protocol, wherein said determination comprises:
identifying identical strings or typosquats performed by said first cybersquatter based on information provided directly or indirectly via the third party protocol and each registered domain in the first cybersquatter's portfolio;
comparing said identical strings or typosquats against a domain name associated with said first brand; and
based on said comparison, identifying at least one registered domain by the first cybersquatter as identical or confusingly similar to the first brand.

11. The method of claim 10, wherein said identical strings or typosquats correspond to substantially identical or common typographical errors of domain names of said plurality of brands.

12. A non-transitory computer-readable storage medium tangibly encoded with computer-executable instructions, that when executed by a processor associated with a computing device, performs a method comprising:
enabling a first user access to a network service, said network service providing access to information associated with a plurality of brands and a plurality of domain registrants or providers of privacy or proxy registration services;
receiving a search query comprising a character string from said first user, said character string comprising identifying information corresponding to a first brand from said at least one of said plurality of brands;
determining based on the search query a first domain registrant or provider of proxy or privacy registration services for an Internet domain name that is identical or confusingly similar to the first brand, said determining comprising identifying serial cybersquatting information related to the first domain registrant or provider of privacy or proxy registration services;
storing said serial cybersquatting information in a database associated with said network service;
determining existence data concerning the existence of a right's holder opportunity to learn more information concerning the right to invoke, or opportunity to actually invoke, legal rights against the first domain name registrant or provider of privacy or proxy registration services via a domain name dispute, the existence data comprising an indication of whether said domain name dispute is in progress and eligible to be joined or shared, or does not yet exist;
if said existence data indicates the domain name dispute is in progress and eligible to be joined or shared, sending information to the first user inviting said first user to join or share in the opportunity;
if said existence data indicates no opportunity yet exists, sending information to the first user inviting the first user to initiate said domain name dispute; and
receiving an action request from said first user based on said serial cybersquatting information and said existence data.

13. The non-transitory computer-readable storage medium of claim 12, further comprising:
initiating the domain name dispute in accordance with the action request from the first user.

14. The non-transitory computer-readable storage medium of claim 13, further comprising:
communicating an indication to a second user that said first user has initiated an opportunity in the domain name dispute, said second user associated with a second brand among said plurality of brands, said second user responsible for joining or sharing said domain name dispute against said first cybersquatter, wherein said first user and said second user share costs of said opportunity.

15. The non-transitory computer-readable storage medium of claim 13, wherein when said first user initiates said domain name dispute, said invocation further comprises:
receiving, from said first user, an invitation for a second user to join said domain name dispute, said second user associated with a second brand from said plurality of brands;
communicating said invitation to said second user;
receiving a second user action indicating an intent to join or share in said domain name dispute, wherein said first user and second user share in costs of said opportunity; and
automatically alerting other brands that serial cybersquatting information exists in relation to said other brands that arises from substantially the same rights that gives rise to the domain name dispute.

16. The non-transitory computer-readable storage medium of claim 12, further comprising:
determining that said first cybersquatter registered a term identical or confusingly similar to said brand of the first user based on information stored in the database associated with said network service, said database comprising record information comprising data indicating a portfolio size of said first cybersquatter and each registered domain within said portfolio.

17. The non-transitory computer-readable storage medium of claim 16, wherein said record information is based upon information provided directly or indirectly via third party protocol, wherein said determination comprises:
identifying identical strings or typosquats performed by said first cybersquatter based on information provided directly or indirectly via the third party protocol and each registered domain in the first cybersquatter's portfolio;
comparing said identical strings or typosquats against a domain name associated with said first brand; and
based on said comparison, identifying at least one registered domain by the first cybersquatter as identical or confusingly similar to the first brand.

18. A system comprising:
at least one computing device comprising:
memory storing computer-executable instructions; and
one or more processors for executing said computer-executable instructions for:
enabling a first user access to a network service, said network service providing access to information associated with a plurality of brands and a plurality of domain registrants or providers of privacy or proxy registration services;
receiving a search query comprising a character string from said first user, said character string comprising identifying information corresponding to a first brand from said at least one of said plurality of brands;
determining based on the search query a first domain registrant or provider of proxy or privacy registration services for an Internet domain name that is identical or confusingly similar to the first brand, said determining comprising identifying serial cybersquatting information related to the first domain registrant or provider of privacy or proxy registration services;
storing said serial cybersquatting information in a database associated with said network service;
determining existence data concerning the existence of a right's holder opportunity to learn more information concerning the right to invoke, or opportunity to actually invoke, legal rights against the first domain name registrant or provider of privacy or proxy registration services via a domain name dispute, the existence data comprising an indication of whether said domain name dispute is in progress and eligible to be joined or shared, or does not yet exist;
if said existence data indicates the domain name dispute is in progress and eligible to be joined or shared, sending information to the first user inviting said first user to join or share in the opportunity;
if said existence data indicates no opportunity yet exists, sending information to the first user inviting the first user to initiate said domain name dispute; and
receiving an action request from said first user based on said serial cybersquatting information and said existence data.

19. The system of claim 18, further comprising:
initiating the domain name dispute in accordance with the action request from the first user; and
communicating an indication to a second user that said first user has initiated an opportunity in the domain name dispute, said second user associated with a second brand among said plurality of brands, said second user responsible for joining or sharing said domain name dispute against said first cybersquatter, wherein said first user and said second user share costs of said opportunity.

20. The system of claim 18, wherein when said first user initiates said domain name dispute, said filing further comprises:
receiving, from said first user, an invitation for a second user to join said domain name dispute, said second user associated with a second brand from said plurality of brands;
communicating said invitation to said second user; and
receiving a second user action indicating an intent to join or share in said domain name dispute, wherein said first user and second user share in costs of said opportunity.
